(19) United States
(12) Patent Application Publication
(10) Pub. No.: US 2025/0315238 A1
(43) Pub. Date: Oct. 9, 2025

(54) CHARGING STATION UPDATE PLATFORM

(71) Applicant: Weavix, Inc., Wichita, KS (US)

(72) Inventors: Kevin TURPIN, Wichita, KS (US); Benjamin BURRUS, Wichita, KS (US)

(21) Appl. No.: 18/625,984

(22) Filed: Apr. 3, 2024

(51) Int. Cl. G06F 8/65; B60L 53/67; B60L 53/68

(52) U.S. Cl. CPC G06F 8/65; B60L 53/67; B60L 53/68

(57) ABSTRACT

Methods, apparatuses, and systems for a charging station update platform are disclosed. A host server transmits software update data to a local network comprised of a charging station bank and one or more wireless devices. Depending on the local area network configuration and/or the communication environment, the software update data is downloaded by one or more wireless devices. The one or more wireless devices subsequently transmit the software update data to the charging station bank, which then transmits the update data to corresponding wireless devices. Alternatively, the charging station bank downloads the software update data directly from the host server and transmits the software update to the one or more wireless devices, and/or the other charging station banks in a charging station network.

### TECHNICAL FIELD

The present disclosure is generally related to wireless communication handset charging stations and systems.

### BACKGROUND

Frontline workers often rely on radios to enable them to communicate with their team members. Traditional radios may fail to provide some communication services, requiring workers to carry additional devices to stay adequately connected to their team. Often, these devices are unfit for in-field use due to their fragile design or their lack of usability during frontline work. For example, smartphones, laptops, or tablets with additional communication capabilities may be easily damaged in the field, difficult to use in a dirty environment or when wearing protective equipment, or overly bulky for daily transportation on site.

Smart radio devices may offer solutions to some of these issues, but this gives rise to further challenges. For example, pushing software updates to a large number of smart radio devices via a mobile network or the Internet may be excessively expensive. Furthermore, smart radio devices may be deployed to challenging communication environments with limited Wi-Fi or Internet access, making it difficult to reliably push software updates to the smart radio devices.

### BRIEF DESCRIPTION OF THE DRAWINGS

FIG. 1 is a block diagram illustrating an example architecture for an apparatus for device communication and tracking, in accordance with one or more embodiments.

FIG. 2 is a drawing illustrating an example apparatus for device communication and tracking, in accordance with one or more embodiments.

FIG. 3 is a drawing illustrating an example charging station for apparatuses implementing device communication and tracking, in accordance with one or more embodiments.

FIGS. 4A-4B are drawings illustrating an example charging station bank for a charging station update platform, in accordance with one or more embodiments.

FIG. 5 is a flow diagram illustrating an example process for a charging station update platform in accordance with one or more embodiments.

FIG. 6A is a drawing illustrating an example environment for apparatuses and communication networks for device communication and tracking, in accordance with one or more embodiments.

FIG. 6B is a flow diagram illustrating an example process for generating a work experience profile, in accordance with one or more embodiments.

FIG. 7 is a drawing illustrating an example facility using apparatuses and communication networks for device communication and tracking, in accordance with one or more embodiments.

FIG. 8 illustrates an example of a worksite that includes a plurality of geofenced areas, in accordance with one or more embodiments.

FIG. 9 is a block diagram illustrating an example machine learning (ML) system, in accordance with one or more embodiments.

FIG. 10 is a block diagram illustrating an example computer system, in accordance with one or more embodiments.

### DETAILED DESCRIPTION

The disclosed technology relates to a charging station update platform. The technology includes a charging station bank, wherein the charging station bank is configured with a memory, a processor, and is configured to communicate via wired, wireless, and machine to machine protocols. The charging station bank is configured with one or more receptacles configured to receive, charge, and transfer data to/from one or more wireless devices. The charging station bank is further configured to communicate with a host server via a backbone network. The charging station bank is configured to receive software update data from (1) the host server, (2) other charging station banks in a charging station network, and/or (3) the one or more wireless devices. Furthermore, the charging station bank is configured to transmit software update data to (1) the other charging station banks in the charging station network, and/or (2) the one or more wireless devices. In some embodiments, one or more of the charging station banks in the charging station network acts as a wireless access point. In some embodiments, one or more of the charging station banks in the charging station network acts as a known fixed location that is used for mesh triangulation.

Some advantages of the disclosed technology include a reduction in data storage and transmission resource needs, resulting in greater cost savings and enhanced scalability. Updating a large set of wireless devices over a mobile network that charges based on data transferred and storage space, both locally (e.g., local devices) and in offsite storage solutions (e.g., the cloud) is expensive. Through the disclosed technology, significantly fewer devices (e.g., as few as a single wireless device or charging station bank) are needed to download a given software update from a backbone network (e.g., the Internet) since the update is transmitted throughout the local network by the charging station bank and wireless devices. Thus, the disclosed technology provides the opportunity to save on costs by reducing the data storage and transmission resources needed to update the wireless devices and charging station banks in the network. The disclosed technology also enhances network scalability since the addition of wireless devices and/or charging station banks to the network do not increase the data storage or transmission resource needs of the network. Since the local network only needs a single wireless device or charging station bank to receive the update from the backbone network, the local network is able to rapidly expand the number of wireless devices and/or charging station banks without incurring additional data storage or transmission needs, and thus, costs.

A further advantage of the disclosed technology is increased reliability and flexibility when pushing software updates to devises on a local network. This is relevant in challenging communication environments that may not have reliably continuous Internet or Wi-Fi connectivity. Because Internet or Wi-Fi connectivity is not always available in frontline environments, frontline devices face challenges in receiving software updates from a host server. The disclosed technology overcomes many of these challenges by providing one or more charging station banks configured with a memory that stores the software update and is configured to provide multiple update pathways for charging station banks and/or wireless devices on a network. In some embodiments, the pathways for a given charging station bank to receive software updates include (1) directly receiving the software update from the host server, (2) receiving the software update from a wireless device, and (3) receiving the software update from another charging station bank. The pathways for a given charging station bank to transmit software updates include (1) transmitting the software update to a wireless device, and (2) transmitting the software update to another charging station bank.

For example, in a communication environment wherein only one of the charging station banks in the charging station network is connected to the backbone network (e.g., the Internet) via a wired connection, the connected charging station bank is enabled to receive a given software update from the host server, and communicate the software update to other charging station banks on a local network through wired (e.g., ethernet), wireless (e.g., a mobile network such as a 5G wireless communication system or a local area network such as one operating on an 802.11 protocol), and/or machine to machine (e.g., Bluetooth, Bluetooth Low-Energy, or ZigBee) protocols. Subsequently, any of the charging station banks that have received the software update are enabled to further transmit the update to other charging station banks in the network. Any of the charging station banks that have received the software update are able to transmit the update to any docked wireless devices. Furthermore, deployed wireless devices (e.g., wireless devices in use throughout a work site) are enabled to receive the update when they are eventually docked (e.g., at the end of a shift). Routine docking allows wireless devices in rotating shift work to remain updated without having to communicate with the backbone network.

As another example, in a communication environment wherein none of the charging station banks in the charging station network are connected to the backbone network, the charging station banks are still able to receive a given software update if one of the wireless devices receives the update from another means (e.g., such as the backbone network). In some embodiments, the wireless device transmits the update by docking with one or more of the charging station banks in the charging station network. Similar as the example above, any of the charging station banks that receives the software update is able to subsequently transmit the update to other charging station banks and/or docked wireless devices. The ability of each of the charging station banks to transmit the update throughout the local network further increases reliability and redundancy by providing that loss of any single charging station bank or wireless device (e.g., for periodic or corrective maintenance) does not preclude the remaining charging station banks from receiving and transmitting the update throughout the network. Moreover, if a single wireless device or charging station bank receives the update, the rest of the local network is still able to receive the software update even if the backbone network and/or host server crashes or goes offline.

As a further example, in a communication environment wherein at least one of the charging station banks in the charging station network has downloaded a given software update, a charging station bank disconnected from the backbone network is still able to receive the update from one or more of the charging station banks that have received the update (e.g., from the backbone network and/or from a wireless device). In some embodiments, the charging station banks in the charging station network are enabled to communicate the software update via a local network through wired (e.g., ethernet), wireless (e.g., a mobile network such as a 5G wireless communication system or a local area network such as one operating on an 802.11 protocol), and/or machine to machine (e.g., Bluetooth, Bluetooth Low-Energy, or ZigBee) protocols. The disconnected charging station bank is enabled to receive the update from the other charging station banks via the local network. Similar as the example above, once the disconnected charging station bank receives the update from another charging station bank, the disconnected charging station bank is able to subsequently transmit the update to other charging station banks and/or docked wireless devices.

Another advantage of the disclosed technology includes improved data tracing capabilities, which enhance network security controls and facilitate analyses of worker behavior and equipment use. Data tracing enables organizations to track and monitor data transmissions within a network. From a network security perspective, data tracing allows for rapid identification of sources of data breaches and/or introductions of malware. The disclosed technology improves data tracing capabilities by providing a record of when and where (e.g., which charging station bank in the charging station network) a wireless device or charging station bank received and/or transmitted potential malware. Furthermore, the record provided by the disclosed technology allows for the identification of common/repeated entry points for data breaches or malware introduction. Thus, the disclosed technology limits the proliferation of malware and mitigates the impact of potential data breaches by identifying security vulnerabilities in the network. Moreover, the disclosed technology reduces the amount of network downtime required to trace a data breach or malware introduction by providing a clear indication of where and when a compromise occurred. Additionally, often, devices lacking appropriate security software updates present increased security vulnerabilities. The disclosed technology enhances network security controls by providing redundant, reliable update pathways that improve the ability of wireless devices to access the latest security software updates.

Improved data tracing capabilities, such as those provided by the disclosed technology, also facilitates analyses of worker behavior and equipment use, which facilitates improved productivity and efficiency. The disclosed technology maintains and provides a record of where and when individual wireless devices on the network have been updated, as well as update frequency. For example, the update frequency data enables tracking worker productivity and/or efficiency by providing an indication of where, when, and the frequency with which a given worker interacts with a given charging station bank. As another example, the disclosed technology provides an indication of how frequently equipment (e.g., a wireless device, a charging station bank, etc.) is being used at a particular location, which facilitates the determination of under- or over-utilized equipment. In some embodiments, utilization data is used to increase productivity and efficiency by facilitating allocation of equipment or other resources from areas of under-utilization to areas that need additional equipment, and/or by facilitating preventative/anticipatory maintenance procedures in areas of over-utilization.

Another benefit of the disclosed technology is to expand wireless network access to frontline wireless devices. In some embodiments, the disclosed technology is configured to operate at least in part as a wireless access point. For example, one or more of the charging station banks in the charging station network is configured to operate as a wireless router providing Internet access to wireless devices.

A further benefit of the disclosed technology is to provide enhanced mesh triangulation for wireless devices on a mesh network. In some embodiments, one or more of the charging station banks in the charging station network operates at least in part as a known fixed location that is used for mesh triangulation of wireless devices. For example, wireless devices that operate as part of a mesh network use the known fixed location of one or more charging station banks to identify accurate range data for wireless devices on the mesh network.

Mobile radio devices (e.g., smart radios) are used to communicate between various workers. As the responsibilities of these workers adapt with technology, however, the functionality of mobile radio devices must evolve to provide additional functionality. For example, mobile radio devices have been improved to increase connectivity in previously disconnected locations. Moreover, improvements in mobile radio devices enable workers to communicate through additional forms of communication, often without user intervention. Mobile radio devices also provide a mechanism for tracking workers and equipment on a worksite to improve safety and efficiency. Mobile radio devices further track details about employees during their work shift, and that information is used to analyze the employees' strengths and weaknesses. Accordingly, the present disclosure relates to improvements in mobile radio devices. In general, improvements are directed to one of four technical aspects (“pillars”): network connectivity, collaboration, location services, and data, which are explained below.

Network connectivity: Smart radios operate using multiple onboard radios and connect to a set of known networks. This pillar refers to radio selection (e.g., use of multiple onboard radios in various contexts) and network selection (e.g., selecting which network to connect to from available networks in various contexts). These decisions may depend on data obtained from other pillars; however, inventions directed to the connectivity pillar have outputs that relate to improvements to network or radio communications/selections.

Collaboration: This pillar relates to communication between users. A collaboration platform includes chat channel selection, audio transcription and interpretation, sentiment analysis, and workflow improvements. The associated smart radio devices further include interface features that improve ease of communication through reduction in button presses and hands-free information delivery. Inventions in this pillar relate to improvements or gained efficiencies in communicating between users and/or the platform itself.

Location services: This pillar refers to various means of identifying the location of devices and people. There are straightforward or primary means, such as the Global Positioning System (GPS), accelerometer, or cellular triangulation. However, there are also secondary means by which known locations (via primary means) are used to derive the location of other unknown devices. For example, a set of smart radio devices with known locations are used to triangulate other devices or equipment. Further location services inventions relate to identification of the behavior of human users of the devices, e.g., micromotions of the device indicate that it is being worn, whereas lack of motion indicates that the device has been placed on a surface. Inventions in this pillar relate to the identification of the physical location of objects or workers.

Data: This pillar relates to the “Internet of Workers” platform. Each of the other pillars leads to the collection of data. Implementation of that data into models provides valuable insights that illustrate a given worksite to users who are not physically present at that worksite. Such insights include productivity of workers, experience of workers, and accident or hazard mapping. Inventions in the data pillar relate to deriving insight or conclusions from one or more sources of data collected from any available sensor in the worksite.

Embodiments of the present disclosure will now be described with reference to the following figures. Although illustrated and described with respect to specific examples, embodiments of the present disclosure can be embodied in many different forms and should not be construed as limited to the embodiments set forth herein. Accordingly, the examples set forth herein are non-limiting examples referenced to improve the description of the present technology.

### Portable Wireless Apparatus

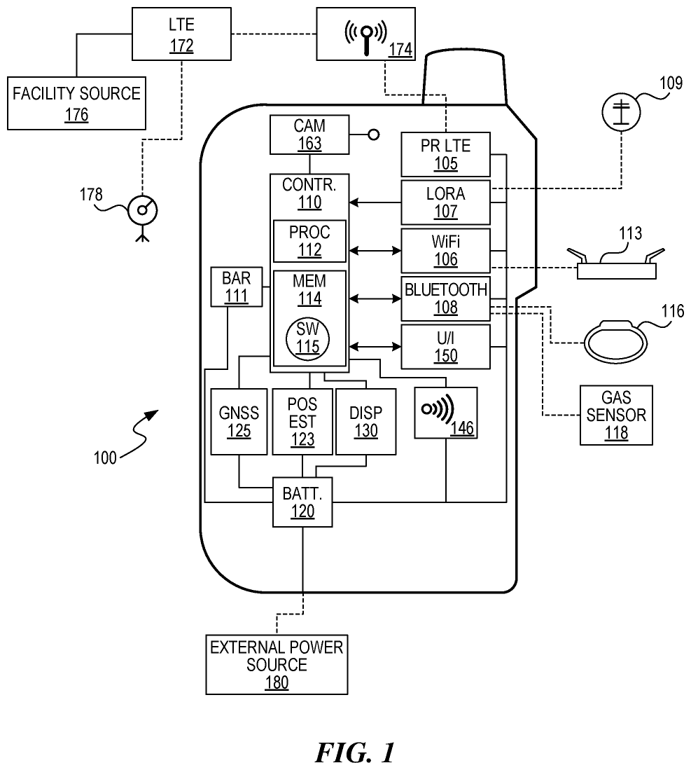

FIG. 1 is a block diagram illustrating an example architecture for an apparatus 100 for device communication and tracking, in accordance with one or more embodiments. The wireless apparatus 100 is implemented using components of the example computer system illustrated and described in more detail with reference to subsequent figures. In embodiments, the apparatus 100 is used to execute the ML system illustrated and described in more detail with reference to subsequent figures. The architecture shown by FIG. 1 is incorporated into a portable wireless apparatus 100, such as a smart radio, a smart camera, a smart watch, a smart headset, or a smart sensor. Although illustrated in a particular configuration, different embodiments of the apparatus 100 include different and/or additional components connected in different ways.

The apparatus 100 includes a controller 110 communicatively coupled either directly or indirectly to a variety of wireless communication arrangements. The apparatus 100 includes a position estimating component 123 (e.g., a dead-reckoning system), which estimates current position using inertia, speed, and intermittent known positions received from a position tracking component 125, which, in embodiments, is a Global Navigation Satellite System (GNSS) component. A battery 120 is electrically coupled with a cellular subsystem 105 (e.g., a private 5G wireless communication subsystem), a Wi-Fi subsystem 106, a low-power wide area network (LPWAN) (e.g., LPWAN/long-range (LoRa) network subsystem 107), a Bluetooth subsystem 108, a barometer 111, an audio device 146, a user interface 150, and a built-in camera 163 for providing electrical power.

The battery 120 is electrically and communicatively coupled with the controller 110 for providing electrical power to the controller 110 and to enable the controller 110 to determine a status of the battery 120 (e.g., a state of charge). In embodiments, the battery 120 is a non-removable rechargeable battery (e.g., using external power source 180). In this way, the battery 120 cannot be removed by a worker to power down the apparatus 100, or subsystems of the apparatus 100 (e.g., the position tracking component 125), thereby ensuring connectivity to the workforce throughout their shift. Moreover, the apparatus 100 cannot be disconnected from the network by removing the battery 120, thereby reducing the likelihood of device theft. In some cases, the apparatus 100 includes an additional, removable battery to enable the apparatus 100 to be used for prolonged periods without requiring additional charging time.

The controller 110 is, for example, a computer having a memory 114, including a non-transitory storage medium for storing software 115, and a processor 112 for executing instructions of the software 115. In some embodiments, the controller 110 is a microcontroller, a microprocessor, an integrated circuit (IC), or a system-on-a-chip (SoC). The controller 110 includes at least one clock capable of providing time stamps or displaying time via display 130. The at least one clock is updatable (e.g., via the user interface 150, the position tracking component 125, the Wi-Fi subsystem 106, the private cellular network 107 subsystem, a server, or a combination thereof).

The wireless communications arrangement includes a cellular subsystem 105, a Wi-Fi subsystem 106, a LPWAN/LoRa network subsystem 107 wirelessly connected to a LPWAN network 109, or a Bluetooth subsystem 108 enabling sending and receiving. Cellular subsystem 105, in embodiments, enables the apparatus 100 to communicate with at least one wireless antenna 174 located at a facility (e.g., a manufacturing facility, a refinery, or a construction site), examples of which may be illustrated in and described with respect to the subsequent figures.

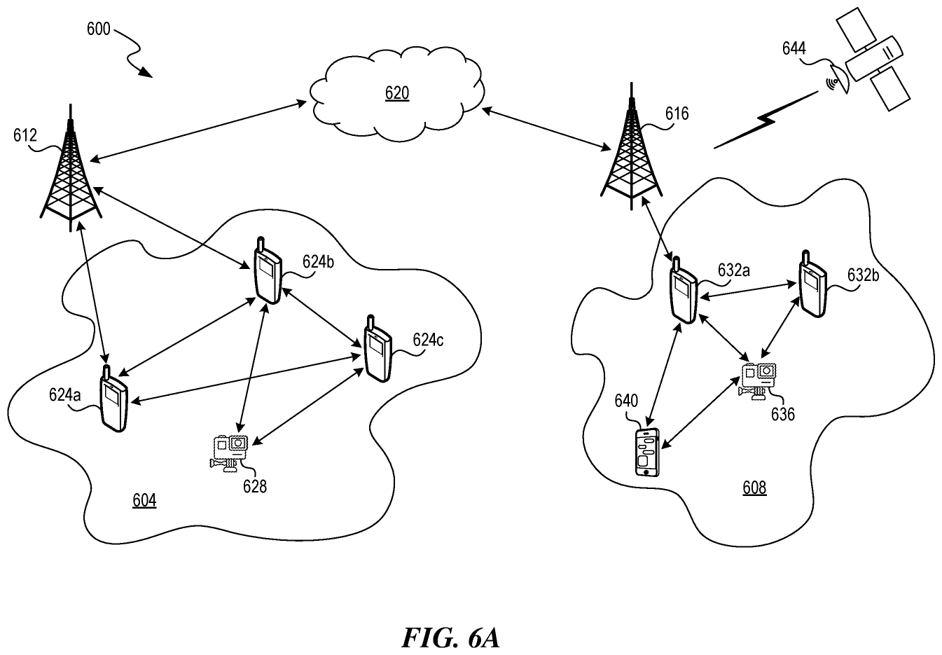

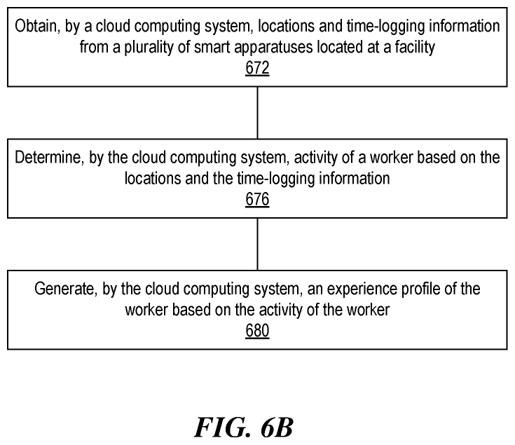

In embodiments, a cellular edge router arrangement 172 is provided for implementing a common wireless source. The cellular edge router arrangement 172 (sometimes referred to as an “edge kit”) provides a wireless connection to the Internet. In embodiments, the LPWAN network 109, the wireless cellular network, or a local radio network is implemented as a local network for the facility usable by instances of the apparatus 100 (e.g., local network 604 illustrated in FIG. 6A). For example, the cellular type can be 2G, 3G, 4G, LTE, 5G, etc. The edge kit 172 is typically located near a facility's primary Internet source 176 (e.g., a fiber backhaul or other similar device). Alternatively, a local network of the facility is configured to connect to the Internet using signals from a satellite source, transceiver, or router 178, especially in a remotely located facility not having a backhaul source, or where a mobile arrangement not requiring a wired connection is desired. More specifically, the satellite source plus edge kit 172 is, in embodiments, configured into a vehicle, or portable system. In embodiments, the cellular subsystem 105 is incorporated into a local or distributed cellular network operating on any of the existing 88 different Evolved Universal Mobile Telecommunications System Terrestrial Radio Access (EUTRA) operating bands (ranging from 700 MHz up to 2.7 GHz). For example, the apparatus 100 operates using a duplex mode implemented using time division duplexing (TDD) or frequency division duplexing (FDD).

The Wi-Fi subsystem 106 enables the apparatus 100 to communicate with an access point 113 capable of transmitting and receiving data wirelessly in a relatively high-frequency band. In embodiments, the Wi-Fi subsystem 106 is also used in testing the apparatus 100 prior to deployment. The Bluetooth subsystem 108 enables the apparatus 100 to communicate with a variety of peripheral devices, including a biometric interface device 116 and a gas/chemical detection sensor 118 used to detect noxious gases. In embodiments, numerous other Bluetooth devices are incorporated into the apparatus 100.

As used herein, the wireless subsystems of the apparatus 100 include any wireless technologies used by the apparatus 100 to communicate wirelessly (e.g., via radio waves) with other apparatuses in a facility (e.g., multiple sensors, a remote interface, etc.), and optionally with the Internet (“the cloud”) for accessing websites, databases, etc. For example, the apparatus 100 is capable of connecting with a conference call or video conference at a remote conferencing server. The apparatus 100 interfaces with a conferencing software (e.g., Microsoft Teams™ Skype™ Zoom™, Cisco Webex™). The wireless subsystems 105, 106, and 108 are each configured to transmit/receive data in an appropriate format, for example, in IEEE 802.11, 802.15, 802.16 Wi-Fi standards, Bluetooth standard, WinnForum Spectrum Access System (SAS) test specification (WINNF-TS-0065), and across a desired range. In embodiments, multiple mobile radio devices are connected to provide data connectivity and data sharing. In embodiments, the shared connectivity is used to establish a mesh network.

The position tracking component 125 and the position estimating component 123 operate in concert. The position tracking component 125 is used to track the location of the apparatus 100. In embodiments, the position tracking component 125 is a GNSS (e.g., GPS, Quasi-Zenith Satellite System (QZSS), BEIDOU, GALILEO, GLONASS) navigational device that receives information from satellites and determines a geographic position based on the received information. The position determined from the GNSS navigation device is augmented with location estimates based on waves received from proximate devices. For example, the position tracking component 125 determines a location of the apparatus 100 relative to one or more proximate devices using receives signal strength indicator (RSSI) techniques, time difference of arrival (TDOA) techniques, or any other appropriate techniques. The relative position is then combined with the position of the proximate devices to determine a location estimate of the apparatus 100, which is used to augment or replace other location estimates. In embodiments, a geographic position is determined at regular intervals (e.g., every five minutes, every minute, every five seconds), and the position in between readings is estimated using the position estimating component 123.

Position data is stored in memory 114 and uploaded to server at regular intervals (e.g., every five minutes, every minute, every five seconds). In embodiments, the intervals for recording and uploading position data are configurable. For example, if the apparatus 100 is stationary for a predetermined duration, the intervals are ignored or extended, and new location information is not stored or uploaded. If no connectivity exists for wirelessly communicating with server 170, location data is stored in memory 114 until connectivity is restored, at which time the data is uploaded and then deleted from memory 114. In embodiments, position data is used to determine latitude, longitude, altitude, speed, heading, and Greenwich mean time (GMT), for example, based on instructions of software 115 or based on external software (e.g., in connection with server 170). In embodiments, position information is used to monitor worker efficiency, overtime, compliance, and safety, as well as to verify time records and adherence to company policies.

In some embodiments, a Bluetooth tracking arrangement using beacons is used for position tracking and estimation. For example, the Bluetooth subsystem 108 receives signals from Bluetooth Low Energy (BLE) beacons located about the facility. The controller 110 is programmed to execute relational distancing software using beacon signals (e.g., triangulating between beacon distance information) to determine the position of the apparatus 100. Regardless of the process, the Bluetooth subsystem 108 detects the beacon signals and the controller 110 determines the distances used in estimating the location of the apparatus 100.

In alternative embodiments, the apparatus 100 uses Ultra-Wideband (UWB) technology with spaced-apart beacons for position tracking and estimation. The beacons are small, battery-powered sensors that are spaced apart in the facility and broadcast signals received by a UWB component included in the apparatus 100. A worker's position is monitored throughout the facility over time when the worker is carrying or wearing the apparatus 100. As described herein, location-sensing GNSS and estimating systems (e.g., the position tracking component 125 and the position estimating component 123) are used to primarily determine a horizontal location. In embodiments, the barometer 111 is used to determine a height at which the apparatus 100 is located (or operates in concert with the GNSS to determine the height) using known vertical barometric pressures at the facility. With the addition of a sensed height, a full three-dimensional location is determined by the processor 112. Applications of the embodiments include determining if a worker is, for example, on stairs or a ladder, atop or elevated inside a vessel, or in other relevant locations.

In embodiments, the display 130 is a touch screen implemented using a liquid-crystal display (LCD), an e-ink display, an organic light-emitting diode (OLED), or other digital display capable of displaying text and images. In embodiments, the display 130 uses a low-power display technology, such as an e-ink display, for reduced power consumption. Images displayed using the display 130 include, but are not limited to, photographs, video, text, icons, symbols, flowcharts, instructions, cues, and warnings.

The audio device 146 optionally includes at least one microphone (not shown) and a speaker for receiving and transmitting audible sounds, respectively. Although only one audio device 146 is shown in the architecture drawing of FIG. 1, it should be understood that in an actual physical embodiment, multiple speakers or microphones can be utilized to enable the apparatus 100 to adequately receive and transmit audio. In embodiments, the speaker has an output around 105 dB to be loud enough to be heard by a worker in a noisy facility. The microphone of the audio device 146 receives the spoken sounds and transmits signals representative of the sounds to the controller 110 for processing.

The apparatus 100 is a shared device that is assigned to a particular user temporarily (e.g., for a shift). In embodiments, the apparatus 100 communicates with a worker ID badge using near field communication (NFC) technology. In this way, a worker may log in to a profile (e.g., stored at a remote server) on the apparatus 100 through their worker ID badge. The worker's profile may store information related to the worker. Examples include name, employee or contractor serial number, login credentials, emergency contact(s), address, shifts, roles (e.g., crane operator), calendars, or any other professional or personal information. Moreover, the user, when logged in, is associated with the apparatus 100. When another user logs in to the apparatus 100, however, that user is then associated with the apparatus 100.

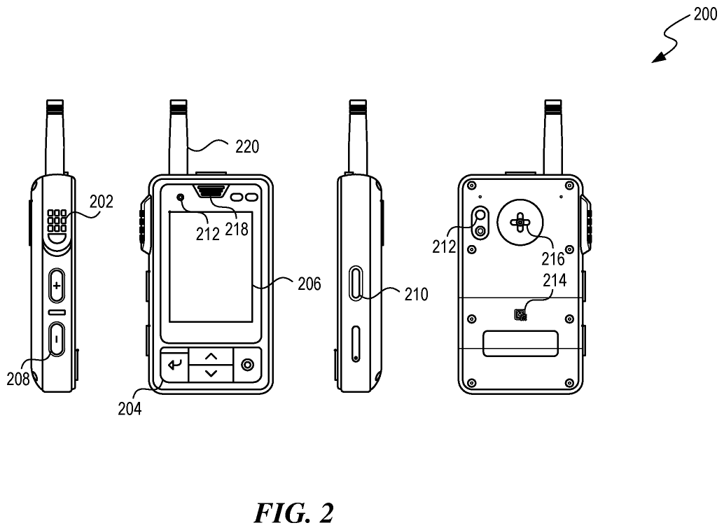

FIG. 2 is a drawing illustrating an example apparatus 200 for device communication and tracking, in accordance with one or more embodiments. The apparatus 200 includes a user interface that includes a PTT button 202, a 4-button user input system 204, a display 206, an easy to grab volume control 208, and a power button 210. The PTT button 202 is used to control the transmission of data from or the reception of data by the apparatus 200. For example, the apparatus 200 may transmit audio data or other data when the PTT button 202 is pressed and receive audio data or other data when the PTT button 202 is released. In other examples, the PTT button 202 may control the transmission of audio data or other data from the apparatus 200 (e.g., transmit when the PTT button 202 is pressed), though apparatus 200 may transmit and receive audio data or other data at the same time (e.g., full duplex communication). The 4-button user input system 204 is used to interact with the apparatus 200. For example, the 4-button user input system 204 is used as a 4-direction input system (e.g., up-down-left-right), a 2-directional-enter-back (e.g., up-down-enter-back), or any other button configuration. The display 206 outputs relevant visual information to the user. In aspects, the display 206 enables touch input by the user to control the apparatus 200. The volume control 208 controls the loudness of the apparatus 200. The power button 210 turns the apparatus 200 on and off.

The apparatus 200 further includes at least one camera 212, an NFC tag 214, a mount 216, at least one speaker 218, and at least one antenna 220. The camera 212 is implemented as a front camera capturing the environment in front of the display 206 or a back camera capturing the environment opposite the display 206. The NFC tag 214 is used to connect or register the apparatus 200. For example, the NFC tag 214 registers the apparatus 200 as being docked in a charging station. In yet another example, the NFC tag connects to a workers badge to associate the apparatus with the worker. The mount 216 is used to attach the apparatus 200 to the worker (e.g., on a utility belt of the worker). The speaker 218 outputs audio received by or presented on the apparatus 200. The volume of the speaker 218 is controlled by the volume control 208. The antenna 220 is used to transmit data from the apparatus 200 or receive data at the apparatus 200. In some cases, transmission or reception by the antenna 220 is controlled by the PTT button 202 or another button of the user interface.

### Charging Station

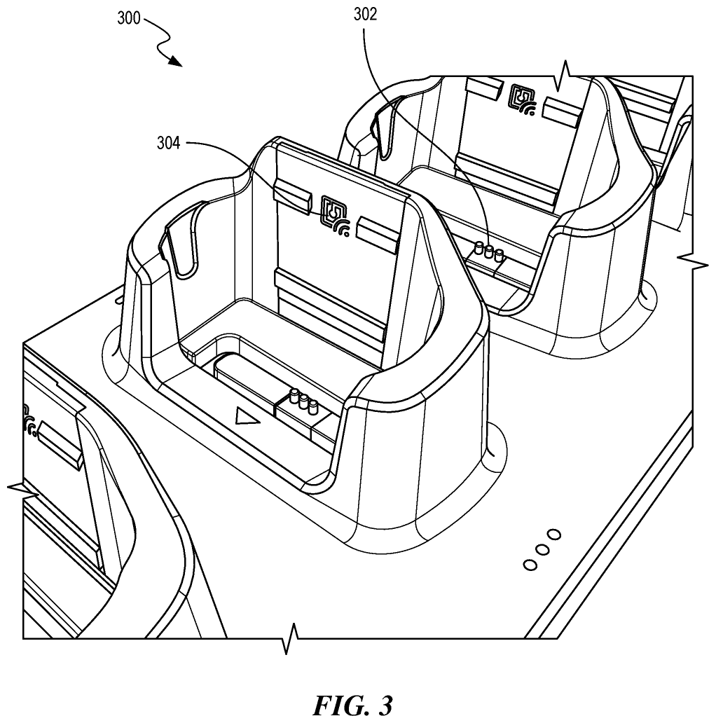

FIG. 3 is a drawing illustrating an example charging station for apparatuses implementing device communication and tracking, in accordance with one or more embodiments. The charging station 300 is used to dock one or more mobile radio devices for charging. In aspects, power is supplied to the mobile radio devices docked at the charging station 300 through charging pins 302 located in each receptacle of the charging station 300. The charging pins 302 are inserted into a charging port of the mobile radio devices. A worker clocking out at a facility places a mobile radio device into the charging station 300. The mobile radio device remains docked until it is removed from the charging station 300 by a worker clocking in at the facility.

The charging station 300 or the mobile radio device determines when the mobile radio device has been docked in the charging station 300. For example, each receptacle of the charging station 300 has an NFC pad 304 that connects with the mobile radio device when the mobile radio device is docked in that receptacle of the charging station 300. Alternatively or additionally, the mobile radio device is determined to be docked in the charging station 300 when the charging pins 302 of a receptacle are inserted into the mobile radio device. In these ways, a cloud computing system is made aware of the location and status (e.g., docked or removed) of the mobile radio device through communication with the charging station 300 or the mobile radio device.

### Charging Station Update Platform

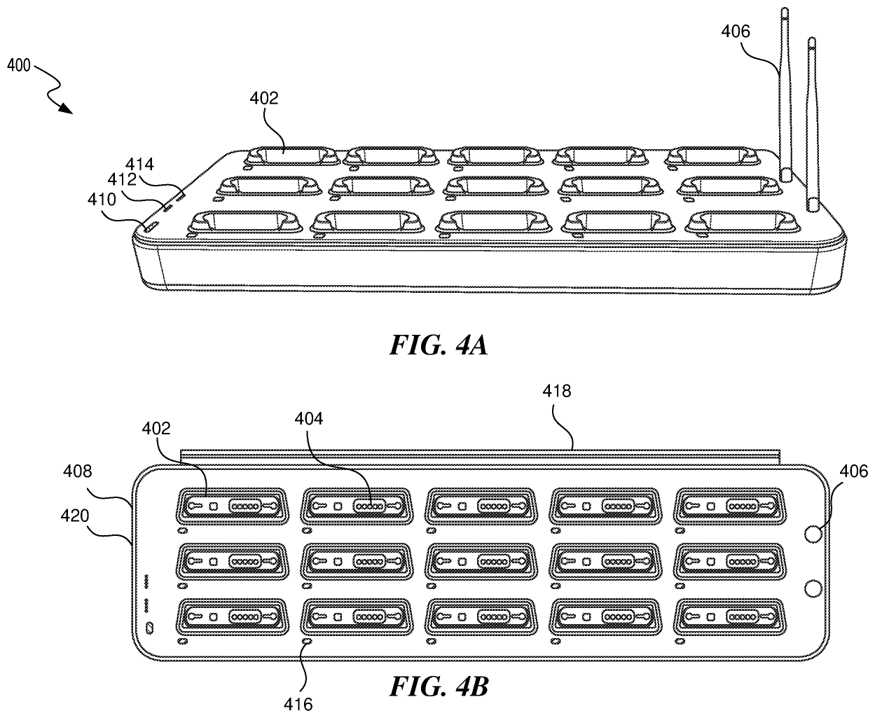

FIGS. 4A-4B are drawings illustrating an example charging station bank for a charging station update platform, in accordance with one or more embodiments. The charging station bank 400 is comprised of one or more receptacles 402. One or more charging pins 404 are located in the one or more receptacles 402. The charging station bank 400 is further comprised of one or more wireless communication components 406, a wired communication component 408, a charging station power status indicator 410, a radio connectivity status indicator 412, a mesh network connectivity status indicator 414, one or more receptacle charging status indicators 416, a mounting apparatus 418, and an external power source connector 420. In some embodiments the charging station bank 400 is configured to include a battery.

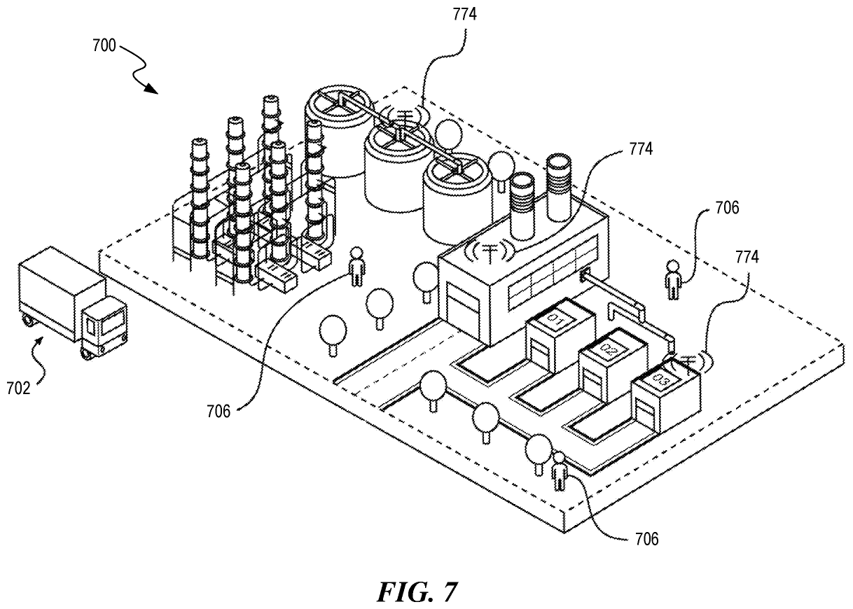

In some embodiments, the charging station bank 400 is configured to be linked together with other charging station banks to form a charging station network (e.g., a plurality of charging station banks 400 communicatively coupled). In some embodiments, the charging station bank 400 operates as a stand-alone device instead of as part of a charging station network. In some embodiments, the charging station bank 400 is comprised substantially of waterproof and/or water resistant materials (e.g., plastic, epoxy compounds, etc.). In some embodiments the charging station bank 400 is mounted on a surface at an entry or exit of a facility (e.g., the facility described in FIG. 7).

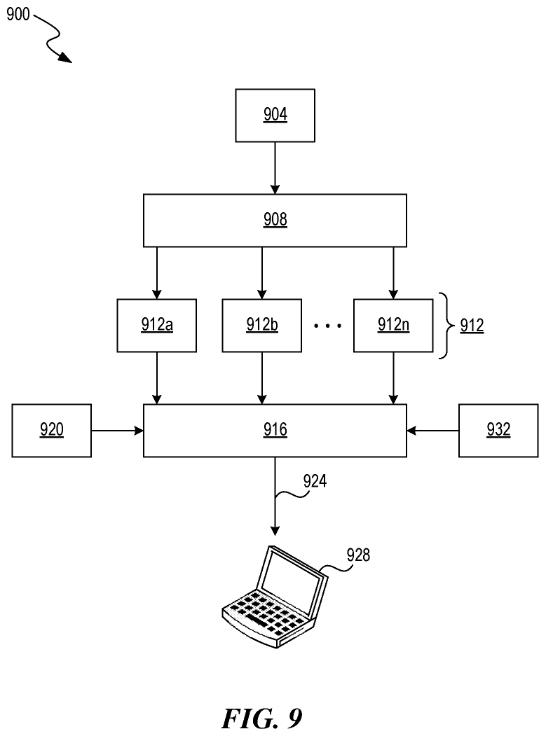

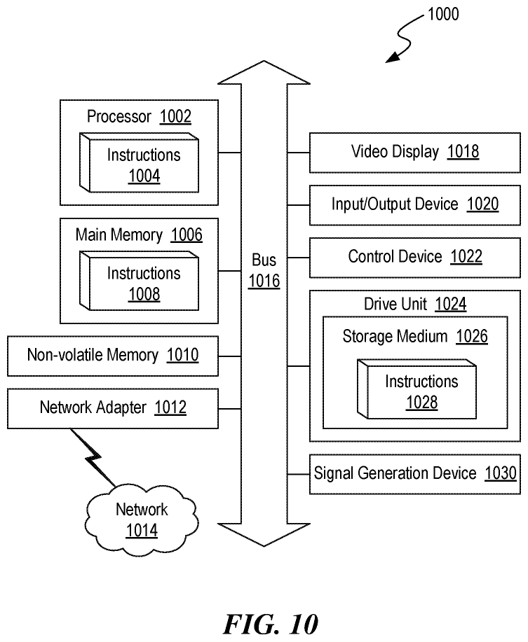

The charging station bank 400 includes a memory, including a non-transitory storage medium for storing software, and a processor for executing instructions of the software. In some embodiments the charging station bank 400 includes a computer architecture similar to the computer system discussed below in FIG. 10. In some embodiments, the charging station bank 400 includes a ML system similar to that discussed below in FIG. 9. In some embodiments the memory and processor are configured to store software version data and execute instructions performing software version checking with wireless devices or other charging station banks 400 communicatively coupled to the charging station bank 400.

Updating a large set of wireless devices over the air is expensive from a data storage and transmission perspective. Furthermore, it can be difficult to ensure wireless device software is maintained up to date in challenging communication environments (e.g., environments where there is limited network connectivity to the Internet or via mobile networks). The present technology overcomes these challenges by providing a charging station update platform in which wireless devices are routinely coupled to the charging station bank 400, which, in some embodiments, is part of a charging station network. The charging station bank 400 includes a memory and processor, as described above. The charging station bank 400 stores updates for the wireless devices. When connected to one of the charging station banks 400, the wireless device and the charging station banks 400 are configured to communicate such that the charging station bank 400 either transmits the local updates to the wireless device, or the wireless device transmits the local updates to the charging station bank 400. The charging station bank 400 is also configured to transmit the local updates to other charging station banks 400 in the charging station network. Thus, wireless devices and charging station banks 400 that are part of a local network are enabled to receive a given software update without requiring a connection to the backbone network. Thus, significantly fewer devices need to download updates from the backbone network (e.g., just a single charging station bank 400 or a single wireless device), reducing data storage and transmission costs and providing reliable, redundant pathways for devices to receive updates.

The receptacles 402 are configured to receive wireless devices. In some embodiments, the wireless devices are configured with the architecture of the apparatus described above in FIGS. 1 and 2. In some embodiments the receptacles 402 are configured similar to the receptacles described above in FIG. 3. For example, the receptacles 402 have an NFC pad that connects with the wireless device when the wireless device is docked in that receptacle 402 of the charging station bank 400. Alternatively or additionally, the wireless device is determined to be docked in the charging station bank 400 when the charging pins 404 of the receptacle 402 are inserted into the wireless device. In these ways, a cloud computing system is made aware of the location and status (e.g., docked or removed) of the wireless device through communication with the charging station bank 400 or the wireless device. In some embodiments the charging pins 404 are configured to enable data transmission in addition to charging capabilities. For example, the charging pins 404 are configured to facilitate USB connectivity (e.g., a micro C type connector). Thus, the wireless device receives and/or transmit software update data to the charging station bank 400 while docked in the receptacle 402.

In some embodiments, encrypted data exchange occurs between the NFC tag and the wireless device. The NFC tag and the wireless device connect for data exchange when brought close together or when the wireless device is placed in the charging station bank 400. The wireless device has an NFC module that connects wirelessly and without an external power source. The nearby connection is limited to one wireless device and protects the data exchange from remote jacking by a malicious entity.

The wireless communication components 406 are configured to enable charging station banks 400 to receive and transmit data (e.g., software update data) via wireless and machine to machine protocols. Specifically, the wireless communication components 406 facilitate the exchange of data (e.g., software update data) between charging station banks 400 in a charging station network, between charging station banks 400 and wireless devices, and between charging station banks 400 and a backbone network (e.g., the Internet). In some embodiments, the wireless communication components 406 include the cellular subsystem, Wi-Fi subsystem, LPWAN/LoRa network subsystem, and/or Bluetooth subsystem architectures described above in FIG. 1. For example, the wireless communication components 406 are transceivers configured to receive and transmit software update data via a wireless connection to the Internet. As another example, the wireless communication components 406 are configured to connect to the Internet using signals from a satellite source, transceiver, or router.

The wireless communication components 406 are configured to transmit/receive data in an appropriate format, for example, in IEEE 802.11, 802.15, 802.16 Wi-Fi standards, Bluetooth standard, WinnForum Spectrum Access System (SAS) test specification (WINNF-TS-0065), and across a desired range. In embodiments, multiple wireless devices and charging stations are connected to provide data connectivity and data sharing. In embodiments, the shared connectivity is used to establish a mesh network.

The wired communication component 408 is configured to enable the charging station bank 400 to receive and transmit data (e.g., software update data) with other devices (e.g., other charging station banks 400 in the charging station network) via a wired connection. In some embodiments, the wired communication component 408 is an ethernet port. For example, a plurality of charging station banks 400 (e.g., a charging station network) are connected via ethernet cabling to form a Local Area Network (LAN).

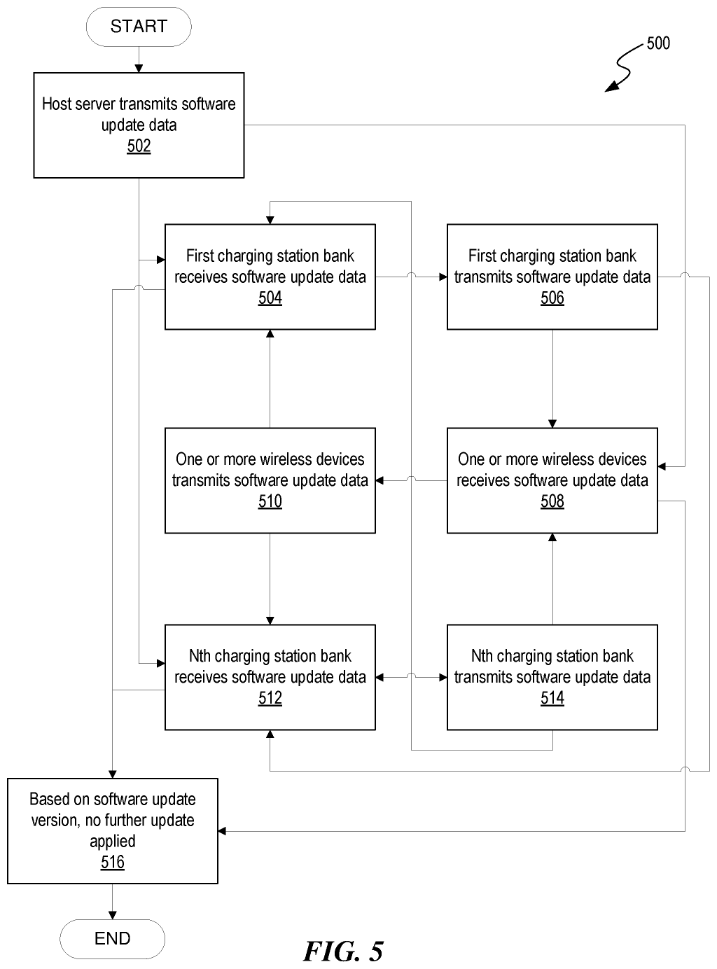

FIG. 5 is a flow diagram illustrating an example process for a charging station update platform in accordance with one or more embodiments. The charging station update platform is comprised of a host server, one or more wireless devices, and a charging station bank. In some embodiments a plurality of charging station banks is linked to form a charging station network. The charging station banks and the wireless devices are configured to operate as part of a local network. The charging station banks are comprised of a memory, including a non-transitory storage medium for storing software, a processor for executing instructions of the software, one or more receptacles configured to receive, provide power to, and communicate with one or more wireless devices, a wireless communication component (e.g., one or more antennas), and a wired communication component (e.g., an ethernet connection). In some embodiments, the charging station update platform is implemented using (1) one or more charging station banks configured in accordance with the architecture shown by FIGS. 3 and 4, and (2) wireless devices (e.g., smart radios) configured in accordance with the architecture shown by FIG. 1. In some embodiments the memory and processors of the charging station banks are configured to store software version data and execute instructions performing software version checking with wireless devices or other charging station banks. In some embodiments the wireless devices are configured to perform software version checking.

In step 502 the host server transmits software update data to the local network via a backbone network (e.g., the Internet). Depending on the local network configuration and/or the communication environment, the software update data is received (e.g., downloaded) by one or more charging station banks and wireless devices. For example, the local network is configured to permit only one of the charging station banks (e.g., a first charging station bank, as described below in step 504), to download the software update data in order to reduce data storage and transmission costs. As another example, the host server transmits the software update data directly to one or more wireless devices (as described below in step 508) if the communication environment is such that the charging station network is disconnected from the backbone network. As a further example, the host server transmits the software update data directly to a second charging station bank, a third charging station bank, a fourth charging station bank, etc. (e.g., an nth charging station bank, as described below in step 512). For simplicity, a charging station bank other than the first charging station bank in the charging station network is referred to as an nth charging station bank, recognizing that this could refer to a second charging station bank, a third charging station bank, a fourth charging station bank, etc.

In step 504 the first charging station bank receives the software update data. Depending on the local network configuration and/or the communication environment (e.g., connectivity status with the backbone network), the first charging station bank directly receives the software update data transmitted by the host server in step 502. The first charging station bank is configured to download the software update data from the host server via the wired communication component and/or wireless communication component. For example, the first charging station bank downloads the software update data from the host server via an ethernet connection. As another example, the first charging station bank downloads the software update from the host server via a Wi-Fi protocol.

In some embodiments, the first charging station bank receives the software update data from one or more wireless devices docked in the first charging station bank receptacles. In some embodiments, data transmission occurs via the charging pins located in the receptacles. For example, the charging pins in the receptacles facilitate data transmission between the one or more wireless devices and the first charging station bank by providing universal serial bus (USB) connectivity (e.g., micro-USB). In some embodiments, data transmission occurs via one or more NFC pads located in the receptacles.

In some embodiments, the first charging station bank receives the software update data from an nth charging station bank in the charging station network. The first charging station bank is configured to receive the software update data from the nth charging station bank via the wired communication component and/or wireless communication component. For example, the first charging station bank receives the software update data from the nth charging station bank via an ethernet connection. As another example, the first charging station bank receives the software update via a private wireless communication subsystem.

In step 506 the first charging station bank transmits the software update data. In some embodiments the first charging station bank transmits the software update data to one or more wireless devices docked at the first charging station bank. As discussed above, in such embodiments, data transmission occurs via the charging pins located in the receptacles. For example, the charging pins in the receptacles facilitate data transmission between the one or more wireless devices and the first charging station bank by providing universal serial bus (USB) connectivity (e.g., micro-USB). Furthermore, in some embodiments, data transmission occurs via one or more NFC pads located in the receptacles. In some embodiments, the first charging station bank performs software version checking for the docked wireless devices before transmitting the software update data, allowing the first charging station bank to determine whether a given wireless device already has the software update data.

In some embodiments the first charging station bank transmits the software update data to an nth charging station bank (e.g., a second charging station bank, a third charging station bank, etc.). The first charging station bank is configured to transmit the software update data to the nth charging station bank via the wired communication component and/or wireless communication component. For example, the first charging station bank transmits the software update data to the nth charging station bank via an ethernet connection. As another example, the first charging station bank transmits the software update via a private wireless communication subsystem. In some embodiments, the first charging station bank performs software version checking for the nth charging station bank before transmitting the software update data, allowing the first charging station bank to determine whether the nth charging station bank already has the software update data.

In step 508 one or more wireless devices receives the software update data. Depending on the local network configuration and/or the communication environment (e.g., connectivity status with the backbone network), one or more wireless devices directly receive the software update data transmitted by the host server in step 502. For example, the one or more wireless devices download the software update from the host server via a Wi-Fi protocol.

In some embodiments, the one or more wireless devices receives the software update data from the first charging station bank while docked in the first charging station bank receptacles. As described above, in some embodiments, data transmission occurs via the charging pins located in the receptacles. For example, the charging pins in the receptacles facilitate data transmission between the one or more wireless devices and the first charging station bank by providing universal serial bus (USB) connectivity (e.g., micro-USB). In some embodiments, data transmission occurs via one or more NFC pads located in the receptacles.

In some embodiments, the one or more wireless devices receives the software update data from an nth charging station bank in the charging station network while docked in the nth charging station bank receptacles. As described above, in some embodiments, data transmission between the one or more wireless devices and the nth charging station bank occurs via the charging pins located in the receptacles of the nth charging station bank. In some embodiments, data transmission occurs via one or more NFC pads located in the receptacles.

In step 510 the one or more wireless devices transmits the software update data. In some embodiments the one or more wireless devices transmits the software update data to the first charging station bank while docked at the first charging station bank. As discussed above, in such embodiments, data transmission occurs via the charging pins located in the receptacles. For example, the charging pins in the receptacles facilitate data transmission between the one or more wireless devices and the first charging station bank by providing universal serial bus (USB) connectivity (e.g., micro-USB). Furthermore, in some embodiments, data transmission occurs via one or more NFC pads located in the receptacles. In some embodiments, the one or more wireless devices performs software version checking for the first charging station bank before transmitting the software update data, allowing the one or more wireless devices to determine whether the first charging station bank already has the software update data.

In some embodiments, the one or more wireless devices transmits the software update data to an nth charging station bank in the charging station network while docked in the nth charging station bank receptacles. As described above, in some embodiments, data transmission between the one or more wireless devices and the nth charging station bank occurs via the charging pins located in the receptacles of the nth charging station bank. In some embodiments, data transmission occurs via one or more NFC pads located in the receptacles. In some embodiments, the one or more wireless devices performs software version checking for the nth charging station bank before transmitting the software update data, allowing the one or more wireless devices to determine whether the nth charging station bank already has the software update data.

In step 512 the nth charging station bank receives the software update data. Depending on the local network configuration and/or the communication environment (e.g., connectivity status with the backbone network), the nth charging station bank directly receives the software update data transmitted by the host server in step 502. The nth charging station bank is configured to download the software update data from the host server via the wired communication component and/or wireless communication component. For example, the nth charging station bank downloads the software update data from the host server via an ethernet connection. As another example, the nth charging station bank downloads the software update from the host server via a Wi-Fi protocol.

In some embodiments, the nth charging station bank receives the software update data from one or more wireless devices docked in the nth charging station bank receptacles. As described above, in some embodiments, data transmission occurs via the charging pins located in the receptacles. For example, the charging pins in the receptacles facilitate data transmission between the one or more wireless devices and the nth charging station bank by providing universal serial bus (USB) connectivity (e.g., micro-USB). In some embodiments, data transmission occurs via one or more NFC pads located in the receptacles.

In some embodiments, the nth charging station bank receives the software update data from the first charging station bank in the charging station network. The nth charging station bank is configured to receive the software update data from the first charging station bank via the wired communication component and/or wireless communication component. For example, the nth charging station bank receives the software update data from the first charging station bank via an ethernet connection. As another example, the nth charging station bank receives the software update via a private wireless communication subsystem.

In some embodiments, the nth charging station bank receives the software update data from another nth charging station bank in the charging station network (e.g., a second charging station bank receives the software update data from a third charging station bank). The nth charging station bank (e.g., the second charging station bank) is configured to receive the software update data from the other nth charging station bank (e.g., the third charging station bank) via the wired communication component and/or wireless communication component. For example, the nth charging station bank receives the software update data from the other nth charging station bank via an ethernet connection. As another example, the nth charging station bank receives the software update via a private wireless communication subsystem.

In step 514 the nth charging station bank transmits the software update data. In some embodiments the nth charging station bank transmits the software update data to one or more wireless devices docked at the nth charging station. As discussed above, in such embodiments, data transmission occurs via the charging pins located in the receptacles. For example, the charging pins in the receptacles facilitate data transmission between the one or more wireless devices and the nth charging station bank by providing universal serial bus (USB) connectivity (e.g., micro-USB). Furthermore, in some embodiments, data transmission occurs via one or more NFC pads located in the receptacles. In some embodiments, the nth charging station bank performs software version checking for the docked wireless devices before transmitting the software update data, allowing the nth charging station bank to determine whether a given wireless device already has the software update data.

In some embodiments the nth charging station bank transmits the software update data to the first charging station bank. The nth charging station bank is configured to transmit the software update data to the first charging station bank via the wired communication component and/or wireless communication component. For example, the nth charging station bank transmits the software update data to the first charging station bank via an ethernet connection. As another example, the nth charging station bank transmits the software update via a private wireless communication subsystem. In some embodiments, the nth charging station bank performs software version checking for the first charging station bank before transmitting the software update data, allowing the nth charging station bank to determine whether the first charging station bank already has the software update data.

In some embodiments the nth charging station bank transmits the software update data to another nth charging station bank (e.g., a second charging station bank transmits to a third charging station bank). The nth charging station bank (e.g., the second charging station bank) is configured to transmit the software update data to the other nth charging station bank (e.g., the third charging station bank) via the wired communication component and/or wireless communication component. For example, the nth charging station bank transmits the software update data to the other nth charging station bank via an ethernet connection. As another example, the nth charging station bank transmits the software update via a private wireless communication subsystem. In some embodiments, the nth charging station bank (e.g., the second charging station bank) performs software version checking for the other nth charging station bank (e.g., the third charging station bank) before transmitting the software update data, allowing the nth charging station bank (e.g., the second charging station bank) to determine whether the other nth charging station bank (e.g., the third charging station bank) already has the software update data.

In step 516 the charging station banks and/or the wireless devices have received the software update, and the update is no longer applied. For example, once the first charging station bank, the nth charging station bank (or nth charging station banks), and the wireless devices in the local network have received the software update, the update is no longer promulgated throughout the local network. In some embodiments the memory and processors of the charging station banks are configured to store software version data and execute instructions performing software version checking with wireless devices and/or other charging station banks. In some embodiments the wireless devices are also configured to perform software version checking. Software version checking by the charging station banks and/or the wireless devices allows for the determination of whether the software update data no longer needs to be promulgated, or whether the update needs to continue being transmitted.

A high-level example follows: a work center designates a first charging station bank to be the only charging station bank in a charging station network (configured as described above) to download software update data transmitted by a host server. The first charging station bank downloads and stores the software update data from the host server (e.g., steps 502 and 504) via a wired communication component (e.g., an ethernet connection). As one or more wireless devices are docked with the first charging station bank (e.g., following completion of a work shift), the first charging station transmits the software update data to the docked wireless devices via charging pins (e.g., micro-USB) located in the first charging station bank's receptacles (e.g., steps 506 and 508). In some embodiments, the first charging station bank performs software version checking for the docked wireless devices before transmitting the software update data, allowing the first charging station bank to determine whether a given wireless device already has the software update data.

The first charging station bank also transmits the software update data to an nth charging station bank (e.g., a second charging station bank, a third charging station bank, etc.) via the wired communication component (e.g., steps 506 and 512). The nth charging station bank is enabled to subsequently provide the software update data to wireless devices docked at the nth charging station bank (e.g., steps 514 and 508), and/or to provide the software update data to additional charging station banks in the charging station network (e.g., steps 514 and 512).

As another high level example: a work center is experiencing difficulties maintaining a connection between a charging station network (configured as described above) and a backbone network including a host server. A wireless device (configured as described above) is successful in establishing a connection with the host server, and is used to download and store software update data transmitted by the host server (e.g., steps 502 and 508). The wireless device is docked in a first charging station bank of the charging station network, and transmits the software update data to the first charging station bank via an NFC pad located in the receptacle in which the wireless device is docked (e.g., steps 510 and 504). The first charging station bank downloads and stores the software update data from the docked wireless device. The first charging station bank then transmits the software update data to other wireless devices docked at the first charging station bank (e.g., steps 506 and 508).

The first charging station bank subsequently transmits the software update data to an nth charging station bank (e.g., a second charging station bank, a third charging station bank, etc.) via a wireless communication component (e.g., steps 506 and 512). The first charging station bank transmits via an antenna over a private network (e.g., based on 5G). The nth charging station bank is enabled to subsequently provide the software update data to wireless devices docked at the nth charging station bank (e.g., steps 514 and 508), and/or to provide the software update data to additional charging station banks in the charging station network (e.g., steps 514 and 512).

### Communication Network

FIG. 6A is a drawing illustrating an example environment 600 for apparatuses and communication networks for device communication and tracking, in accordance with one or more embodiments. The environment 600 includes a cloud computing system 620, cellular transmission towers 612, 616, and local networks 604, 608. Components of the environment 600 are implemented using components of the example computer system illustrated and described in more detail with reference to subsequent figures. Likewise, different embodiments of the apparatus 100 include different and/or additional components and are connected in different ways.

Smart radios 624 (e.g., smart radios 624a-624c), smart radios 632 (e.g., smart radios 632a-b) and smart cameras 628, 636 are implemented in accordance with the architecture shown by FIG. 1. In embodiments, smart sensors implemented in accordance with the architecture shown by FIG. 1 are also connected to the local networks 604, 608 and mounted on a surface of a worksite, or worn or carried by workers. For example, the local network 604 is located at a first facility and the local network 608 is at a second facility. In embodiments, each smart radio and other smart apparatus has two Subscriber Identity Module (SIM) cards, sometimes referred to as dual SIM. A SIM card is an IC intended to securely store an international mobile subscriber identity (IMSI) number and its related key, which are used to identify and authenticate subscribers on mobile telephony devices.

A first SIM card enables the smart radio 624a to connect to the local (e.g., cellular) network 604 and a second SIM card enables the smart radio 624a to connect to a commercial cellular tower (e.g., cellular transmission tower 612) for access to mobile telephony, the Internet, and the cloud computing system 620 (e.g., to major participating networks such as Verizon™, AT&T™ T-Mobile™, or Sprint™). In such embodiments, the smart radio 624a has two radio transceivers, one for each SIM card. In other embodiments, the smart radio 624a has two active SIM cards, and the SIM cards both use only one radio transceiver. However, the two SIM cards are both active only as long as both are not in simultaneous use. As long as the SIM cards are both in standby mode, a voice call could be initiated on either one. However, once the call begins, the other SIM card becomes inactive until the first SIM card is no longer actively used.

In embodiments, the local network 604 uses a private address space of Internet protocol (IP) addresses. In other embodiments, the local network 604 is a local radio-based network using peer-to-peer (P2P) two-way radio (duplex communication) with extended range based on hops (e.g., from smart radio 624a to smart radio 624b to smart radio 624c). Hence, radio communication is transferred similarly to addressed packet-based data with packet switching by each smart radio or other smart apparatus on the path from source to destination. For example, each smart radio or other smart apparatus operates as a transmitter, receiver, or transceiver for the local network 604 to serve a facility. The smart apparatuses serve as multiple transmit/receive sites interconnected to achieve the range of coverage required by the facility. Further, the signals on the local networks 604, 608 are backhauled to a central switch for communication to the cellular transmission towers 612, 616.

In embodiments (e.g., in more remote locations), the local network 604 is implemented by sending radio signals between multiple smart radios 624. Such embodiments are implemented in less-inhabited locations (e.g., wilderness) where workers are spread out over a larger work area that may be otherwise inaccessible to commercial cellular service. An example is where power company technicians are examining or otherwise working on power lines over larger distances that are often remote. The embodiments are implemented by transmitting radio signals from a smart radio 624a to other smart radios 624b, 624c on one or more frequency channels operating as a two-way radio. The radio messages sent include a header and a payload. Such broadcasting does not require a session or a connection between the devices. Data in the header is used by a receiving smart radio 624b to direct the “packet” to a destination (e.g., smart radio 624c). At the destination, the payload is extracted and played back by the smart radio 624c via the radio's speaker.

For example, the smart radio 624a broadcasts voice data using radio signals. Any other smart radio 624b within a range limit (e.g., 1 mile, 2 miles, etc.) receives the radio signals. The radio data includes a header having the destination of the message (smart radio 624c). The radio message is decrypted/decoded and played back on only the destination smart radio 624c. If another smart radio 624b that was not the destination radio receives the radio signals, the smart radio 624b rebroadcasts the radio signals rather than decoding and playing them back on a speaker. The smart radios 624 are thus used as signal repeaters. The advantages and benefits of the embodiments disclosed herein include extending the range of two-way radios or smart radios 624 by implementing radio hopping between the radios.

In embodiments, the local network 604 is implemented using Citizens Broadband Radio Service (CBRS). The use of CBRS Band 48 (from 3550 MHz to 3700 MHz), in embodiments, provides numerous advantages. For example, the use of CBRS Band 48 provides longer signal ranges and smoother handovers. The use of CBRS Band 48 supports numerous smart radios 624 and smart cameras 628 at the same time. A smart apparatus is therefore sometimes referred to as a Citizens Broadband Radio Service Device (CBSD).

In alternative embodiments, the Industrial, Scientific, and Medical (ISM) radio bands are used instead of CBRS Band 48. It should be noted that the particular frequency bands used in executing the processes herein could be different, and that the aspects of what is disclosed herein should not be limited to a particular frequency band unless otherwise specified (e.g., 4G-LTE or 5G bands could be used). In embodiments, the local network 604 is a private cellular (e.g., LTE) network operated specifically for the benefit of the facility. Only authorized users of the smart radios 624 have access to the local network 604. For example, the local network 604 uses the 900 MHz spectrum. In another example, the local network 604 uses 900 MHz for voice and narrowband data for Land Mobile Radio (LMR) communications, 900 MHz broadband for critical wide area, long-range data communications, and CBRS for ultra-fast coverage of smaller areas of the facility, such as substations, storage yards, and office spaces.

The smart radios 624 communicate using other communication technologies, for example, Voice over IP (VoTP), Voice over Wi-Fi (VoWiFi), or Voice over Long-Term Evolution (VoLTE). The smart radios 624 connect to a communication session (e.g., voice call, video call) for real-time communication with specific devices. The communication sessions include devices within or outside of the local network 604 (e.g., in the local network 608). The communication sessions are hosted on a private server (e.g., of the local network 604) or a remote server (e.g., accessible through the cloud computing system 620). In other aspects, the session is P2P.

The cloud computing system 620 delivers computing services—including servers, storage, databases, networking, software, analytics, and intelligence—over the Internet to offer faster innovation, flexible resources, and economies of scale. FIG. 6A depicts an exemplary high-level, cloud-centered network environment 600 otherwise known as a cloud-based system. Referring to FIG. 6A, it can be seen that the environment centers around the cloud computing system 620 and the local networks 604, 608. Through the cloud computing system 620, multiple software systems are made to be accessible by multiple smart radios 624, 632, smart cameras 628, 636, as well as more standard devices (e.g., a smartphone 640 or a tablet) each equipped with local networking and cellular wireless capabilities. In some embodiments, each of the apparatuses 624, 628, 640, although diverse, embodies the architecture of the apparatus 100 shown by FIG. 1, but are distributed to different kinds of users or mounted on surfaces of the facility. For example, the smart radio 624a is worn by employees or independently contracted workers at a facility. The CBRS-equipped smartphone 640 is utilized by an on- or offsite supervisor. The smart camera 628 is utilized by an inspector or another person wanting to have improved display or other options. Regardless, it should be recognized that numerous apparatuses are utilized in combination with an established cellular network (e.g., CBRS Band 48 in embodiments) to provide the ability to access the cloud software applications from the apparatuses (e.g., smart radios 624, 632, smart cameras 628, 636, smartphone 640).

In embodiments, the cloud computing system 620 and local networks 604, 608 are configured to send communications to the smart radios 624, 632 or smart cameras 628, 636 based on analysis conducted by the cloud computing system 620. The communications enable the smart radio 624 or smart camera 628 to receive warnings, etc., generated as a result of analysis conducted. The employee-worn smart radio 624a (and possibly other devices including the architecture of the apparatus 100, such as the smart cameras 628, 636) is used along with the peripherals shown in FIG. 1 to accomplish a variety of objectives. For example, workers, in embodiments, are equipped with a Bluetooth-enabled gas-detection smart sensor. The smart sensor detects the existence of a dangerous gas, or gas level. By connecting through the smart radio 624a or directly to the local network 604, the readings from the smart sensor are analyzed by the cloud computing system 620 to implement a course of action due to sensed characteristics of toxicity. The cloud computing system 620 sends out an alert to the smart radio 624 or smart camera 628, and thus a worker, for example, uses a speaker or alternative notification means to alert other workers so that they can avoid danger.

### Position Estimation

The environment 600 includes one or more satellites 644. The smart radios 624 receive signals from the satellites 644 that are usable to determine position estimates. For example, the smart radios 624 include a positioning system that implements a GNSS or other network triangulation/position system. In some embodiments, the locations of the smart radios 624 are determined from satellites, for example, GPS, QZSS, BEIDOU, GALILEO, and GLONASS. In some cases, the position determined from the primary positioning system does not satisfy a minimum accuracy requirement, the primary position can only be determined at predetermined intervals, or the primary position cannot be determined at all. Accordingly, additional positioning techniques can be used to augment or replace primary positioning. For example, the smart radio 624a tracks its position based on broadcast signals received from proximate devices (e.g., using RSSI techniques or TDOA techniques). In some embodiments, the proximate devices include devices that have transmission ranges that encompass the location of the smart radio 624a (e.g., smart radios 624b, 624c). In some embodiments, the smart radios 624 determine or augment a secondary position estimate based on broadcasts received from a cellular communication tower (e.g., cellular transmission tower 612).

RSSI techniques include using the strength signals within a broadcast signal to determine the distance of a receiver from a transmitter. For instance, a receiver is enabled to determine the signal-to-noise ratio (SNR) of a received signal within a broadcast from a transmitter. The SNR of the received signal is related to the distance between a receiver and a transmitter. Thus, the distance between the receiver and the transmitter is estimated based on the SNR. By determining a receiver's distance from multiple transmitters, the receiver's position is determined through localization (e.g., triangulation). In some cases, RSSI techniques become less accurate at larger distances. Accordingly, proximate devices may be required to be within a particular distance for RSSI techniques.

TDOA techniques include using the timing at which broadcast signals are received to determine the distance of a receiver from a transmitter. For example, a broadcast signal is sent by a transmitter at a known time (e.g., predetermined intervals). Thus, by determining the time at which the broadcast signal is received (e.g., using a clock), the travel time of the broadcast signal is determined. The distance of the smart radios 624 from one another is thus determined based on the wave speed. In some implementations, as broadcast signals are received from the transmitters, the smart radios 624 determine its relative position from each transmitter through localization, resulting in a more accurate global position (e.g., triangulation). Thus, TDOA techniques are used to determine device location.

In aspects, the broadcast signals transmitted by proximate devices include information related to a position. For example, broadcast signals sent from the smart radios 624 identify their current location. Broadcast signals sent from cellular communication towers or other stationary devices may not need to include a current location, as the location may be known to the receiving device. In other cases, a cellular communication tower or other stationary device sends a broadcast signal that includes information indicative of a current location of the tower or stationary device. Using the current location of the transmitting devices and the location of the smart radios (e.g., smart radios 624b, 624c) relative to the transmitting devices, a global position of the smart radio 624a determined.

In some cases, a barometer is used to augment the position determination of the smart radios 624. For example, RSSI, TDOA, and other techniques are used to determine the distance between a transmitter and a receiver. However, these techniques may not provide information related to the displacement between the transmitter and the receiver (e.g., whether the distance is in the x, y, or z plane). In some cases, the barometer is used to provide relative displacement information (e.g., based on atmospheric conditions) of the smart radios 624. In aspects, the broadcast signals received from the proximate devices include information relating to respective elevation estimates (e.g., determined by barometers at the proximate devices) at each of the proximate devices. The elevation estimates from the proximate devices are compared to the elevation estimate of the smart radio 624a to determine the difference in elevation between the smart radio 624a and the proximate devices (e.g., smart radios 624b, 624c).

In some cases, a target device estimates a location based on proximate devices without analyzing broadcast signals. For example, proximate devices shares their calculated location data. The target device (e.g., smart radio 624a) receives location data via any communication technology (e.g., Bluetooth or another short-range communication). One device (e.g., smart radio 624b) shares that it is at location A and another device (e.g., smart radio 624c) is at location B. The target device estimates that it is located somewhere near A and B (e.g., within a communication range of A and B using the respective communication mechanism). In another aspect, the target device receives location data from multiple proximate devices and combines (e.g., average) the location data to estimate its position. In yet another example, the target device receives location data from proximate devices via a first communication and uses a second communication to determine the location of the target device relative to the proximate devices. In this way, the location data need not be communicated in the same communication used to determine the relative location of the target device.

As an example, the smart radio 624b determines its location based on a primary location estimate that is augmented with a secondary location estimate. For example, the smart radio 624b receives a primary location estimate. In aspects, the primary location estimate is a GNSS location determined from the satellite 644 or a location estimate determined by communications with the cellular communication tower 612 (e.g., using TDOA, RSSI, or other techniques). In some implementations, the primary location estimate has a measurement error less than 1 foot, 2 feet, 5 feet, 10 feet, or the like. The measurement error may increase based on an environment of the smart radio 624b. For example, the measurement error may be higher if the smart radio 624b is within or surrounded by a densely constructed building.

To improve the measurement accuracy, the smart radio 624b augments its primary location estimate based on a secondary location estimate. In aspects, the secondary location estimate is determined from broadcast signals transmitted by smart radio 624a, smart radio 624c, smart camera 628, cellular communication tower 612, or another communication device or node (e.g., an access point). Positioning techniques (e.g., TDOA, RSSI, location sharing, or other techniques) are used to determine a relative distance from the transmitting device. For example, smart radio 624a, smart radio 624c, and smart camera 628 transmit broadcast signals that enable the distance of the smart radio 624b to be determined relative to each transmitting device. The transmitting devices can be stationary or moving. Stationary objects typically have strong or high confidence location data (e.g., immobile objects are plotted accurately to maps). The relative location of the smart radio 624b is determined through triangulation based on the distance from each transmitting device. For example, the relative location of the smart radio 624b is determined through triangulation based on the distance from the known location of a charging station bank in a charging station network (described above in FIGS. 4-5). In aspects, the secondary location estimate has a measurement error of less than 1 inch, 2 inches, 6 inches, or 1 foot. In aspects, the secondary location estimate replaces with the primary location estimate or is averaged with the primary location estimate to determine an augmented position estimate with reduced error. Accordingly, the measurement error of the location estimate of the smart device 624b is improved by augmenting the primary location estimate with the secondary location estimate.

In some implementations, the location of the equipment is similarly monitored. In this context, mobile equipment refers to worksite or facility industrial equipment (e.g., heavy machinery, precision tools, construction vehicles). According to example embodiments, a location of a mobile equipment is continuously monitored based on repeated triangulation from multiple smart radios 624 located near the mobile equipment (e.g., using tags placed on the mobile equipment). Improvements to the operation and usage of the mobile equipment are made based on analyzing the locations of the mobile equipment throughout a facility or worksite. Locations of the mobile equipment are reported to owners of the mobile equipment or entities that own, operate, and/or maintain the mobile equipment. Mobile equipment whose location is tracked includes vehicles, tools used and shared by workers in different facility locations, toolkits and toolboxes, manufactured and/or packaged products, and/or the like. Generally, mobile equipment is movable between different locations within the facility or worksite at different points in time.

Various monitoring operations are performed based on the locations of the mobile equipment that are determined over time. In some embodiments, a usage level for the mobile equipment is automatically classified based on different locations of the mobile equipment over time. For example, a mobile equipment having frequent changes in location within a window of time (e.g., different locations that are at least a threshold distance away from each other) is classified at a high usage level compared to a mobile equipment that remains in approximately the same location for the window of time. In some embodiments, certain mobile equipment classified with high usage levels are indicated and identified to maintenance workers such that usage-related failures or faults can be preemptively identified.

In some embodiments, a resting or storage location for the mobile equipment is determined based on the monitoring of the mobile equipment location. For example, an average spatial location is determined from the locations of the mobile equipment over time. A storage location based on the average spatial location is then indicated in a recommendation provided or displayed to an administrator or other entity that manages the facility or worksite.

In some embodiments, locations of multiple mobile equipment are monitored so that a particular mobile equipment is recommended for use to a worker during certain events or scenarios. As another example, for a worker assigned with a maintenance task at a location within a facility, one or more maintenance toolkits shared among workers and located near the location are recommended to the worker for use.

Accordingly, embodiments described herein provide local detection and monitoring of mobile equipment locations. Facility operation efficiency is improved based on the monitoring of mobile equipment locations and analysis of different mobile equipment locations.

### Machine-Defined Interactions

The cloud computing system 620 uses data received from the smart radios 624, 632 and smart cameras 628, 636 to track and monitor machine-defined activity of workers based on locations worked, times worked, analysis of video received from the smart cameras 628, 636, etc. The activity is measured by the cloud computing system 620 in terms of at least one of a start time, a duration of the activity, an end time, an identity (e.g., serial number, employee number, name, seniority level, etc.) of the worker performing the activity, an identity of the equipment(s) used by the worker, or a location of the activity. For example, a smart radio 624a carried or worn by a worker would track that the position of the smart radio 624a is in proximity to or coincides with a position of the particular machine.

The activity is measured by the cloud computing system 620 in terms of at least the location of the activity and one of a duration of the activity, an identity of the worker performing the activity, or an identity of the equipment(s) used by the worker. In embodiments, the ML system is used to detect and track activity, for example, by extracting features based on equipment types or manufacturing operation types as input data. For example, a smart sensor mounted on an oil rig transmits to and receives signals from a smart radio 624a carried or worn by a worker to log the time the worker spends at a portion of the oil rig.

Worker activity involving multiple workers can similarly be monitored. These activities are measured by the cloud computing system 620 in terms of at least one of a start time, a duration of the activity, an end time, identities (e.g., serial numbers, employee numbers, names, seniority levels, etc.) of the workers performing the activity, an identity of the equipment(s) used by the workers, or a location of the activity. Group activities are detected and monitored using location tracking of multiple smart apparatuses. For example, the cloud computing system 620 tracks and records a specific group activity based on determining that two or more smart radios 624 were located in proximity to one another within a particular worksite for a predetermined period of time. For example, a smart radio 624a transmits to and receives signals from other smart radios 624b, 624c carried or worn by other workers to log the time the worker spends working together in a team with the other workers.

In embodiments, a smart camera 628 mounted at the worksite captures video of one or more workers working in the facility and performs facial recognition (e.g., using the ML system). The smart camera 628 identify the equipment used to perform an activity or the tasks that a worker is performing. The smart camera 628 sends the location information to the cloud computing system 620 for generation of activity data. In embodiments, an ML system is used to detect and track activity (e.g., using features based on geographic locations or facility types as input data).

The cloud computing system 620 determines various metrics for monitored workers based on the activity data. For example, the cloud computing system 620 determines a response time for a worker. The response time refers to the time difference between receiving a call to report to a given task and the time of arriving at a geofence associated with the task. In aspects, the cloud computing system 620 determines a repair metric, which measures the effectiveness of repairs by a worker, based on the activity data. For example, the effectiveness of repairs is machine observable based on a length of time a given object remains functional as compared to an expected time of functionality (e.g., a day, a few months, a year, etc.). In yet another aspect, the activity data is analyzed to determine efficient routes to different areas of a worksite, for example, based on routes traveled by monitored workers. Activity data is analyzed to determine the risk to which each worker is exposed, for example, based on how much time a worker spends in proximity to hazardous material or performing hazardous tasks. The ML system analyzes the various metrics to monitor workers or reduce risk.

### Worker Experience Profile

The cloud computing system 620 hosts the software functions to track activities to determine performance metrics and time spent at different tasks and with different equipment and to generate work experience profiles of frontline workers based on interfacing between software suites of the cloud computing system 620 and the smart radios 624, 632, smart cameras 628, 636, smartphone 640. Tracking of activities is implemented in, for example, Scheduling Systems (SS), Field Data Management (FDM) systems, and/or Enterprise Resource Planning (ERP) software systems that are used to track and plan for the use of facility equipment and other resources. Manufacturing Management System (MMS) software is used to manage the production and logistics processes in manufacturing industries (e.g., for the purpose of reducing waste, improving maintenance processes and timing, etc.). Risk-Based Inspection (RBI) software assists the facility using optimized maintenance business processes to examine equipment and/or structures, and track activities prior to and after a breakdown in equipment, detection of manufacturing failures, or detection of operational hazards (e.g., detection of gas leaks in the facility). The amount of time each worker logs at a machine-defined activity with respect to different locations and different types of equipment is collected and used to update an “experience profile” of the worker on the cloud computing system 620 in real time.

FIG. 6B is a flow diagram illustrating an example process for generating a work experience profile using smart radios 624a, 624b, and local networks 604, 608 for device communication and tracking, in accordance with one or more embodiments. The smart radios 624 and local networks 604, 608 are illustrated and described in more detail with reference to FIG. 6A. In embodiments, the process of FIG. 6B is performed by the cloud computing system 620 illustrated and described in more detail with reference to FIG. 6A. In embodiments, the process of FIG. 6A is performed by a computer system, for example, the example computer system illustrated and described in more detail with reference to subsequent figures. Particular entities, for example, the smart radios 624 or the local network 604, perform some or all of the steps of the process in embodiments. Likewise, embodiments include different and/or additional steps, or perform the steps in different orders.

In step 672, the cloud computing system 620 obtains locations and time-logging information from multiple smart apparatuses (e.g., smart radios 624) located at a facility. The locations describe movement of the multiple smart apparatuses with respect to the time-logging information. For example, the cloud computing system 620 keeps track of shifts, types of equipment, and locations worked by each worker, and uses the information to develop the experience profile automatically for the worker, including formatting services. When the worker joins an employer or otherwise signs up for the service, relevant personal information is obtained by the cloud computing system 620 to establish payroll and other known employment particulars. The worker uses a smart radio 624a to engage with the cloud computing system 620 and works shifts for different positions.

In step 676, the cloud computing system 620 determines activity of a worker based on the locations and the time-logging information. The activities describe work performed by one or more workers with equipment of the facility (e.g., lathes, lifts, crane, etc.). For example, the activities include tasks performed by the worker, equipment worked with by the worker, time spent on a task or with a piece of equipment, or any other relevant information. In some cases, the activities are used to log accidents that occur at the worksite. The activities also include various performance metrics determined from the location and the time-logging information.

In step 680, the cloud computing system 620 generates the experience profile of the worker based on the activity of the worker. The cloud computing system 620 automatically fills in information determined from the activity of the worker to build the experience profile of the worker. The data filled into the field space of the experience profile include the specific number of hours that a worker has spent working with a particular type of equipment (e.g., 200 hours spent driving forklifts, 150 hours spent operating a lathe, etc.). The experience profile further includes various performance metrics associated with a particular task or piece of equipment. In embodiments, the cloud computing system 620 exports or publishes the experience profile to a user profile of a social or professional networking platform (e.g., such as LinkedIn™, Monster™, any other suitable social media or proprietary website, or a combination thereof). In embodiments, the cloud computing system 620 exports the experience profile in the form of a recommendation letter or reference package to past or prospective employers. The experience data enables a given worker to prove that they have a certain amount of experience with a given equipment platform.

### Example Facility

FIG. 7 is a drawing illustrating an example facility 700 using apparatuses and communication networks for device communication and tracking, in accordance with one or more embodiments. For example, the facility 700 is a refinery, a manufacturing facility, a construction site, etc. The communication technology shown by FIG. 7 is implemented using components of the example computer systems illustrated and described in more detail with reference to the other figures herein.

Multiple differently and strategically placed wireless antennas 774 are used to receive signals from an Internet source (e.g., a fiber backhaul at the facility), or a mobile system (e.g., a truck 702). The truck 702, in embodiments, implements an edge kit used to connect to the Internet. The strategically placed wireless antennas 774 repeat the signals received and sent from the edge kit such that a private cellular network is made available to multiple workers 706. Each worker carries or wears a cellular-enabled smart radio, implemented in accordance with the embodiments described herein. A position of the smart radio is continually tracked during a work shift.

In implementations, a stationary, temporary, or permanently installed cellular (e.g., LTE or 5G) source is used that obtains network access through a fiber or cable backhaul. In embodiments, a satellite or other Internet source is embodied into hand-carried or other mobile systems (e.g., a bag, box, or other portable arrangement). For example, a charging station bank in a charging station network (as described above in FIGS. 4-5) acts as a wireless access point to facilitate wireless Internet access. FIG. 7 shows that multiple wireless antennas 774 are installed at various locations throughout the facility. Where the edge kit is located at a location near a facility fiber backhaul, the communication system in the facility 700 uses multiple omnidirectional Multi-Band Outdoor (MBO) antennas as shown. Where the Internet source is instead located near an edge of the facility 700, as is often the case, the communication system uses one or more directional wireless antennas to improve the coverage in terms of bandwidth. Alternatively, where the edge kit is in a mobile vehicle, for example, truck 702, the antennas' directional configuration would be picked depending on whether the vehicle would ultimately be located at a central or boundary location.

In embodiments where a backhaul arrangement is installed at the facility 700, the edge kit is directly connected to an existing fiber router, cable router, or any other source of Internet at the facility. In embodiments, the wireless antennas 774 are deployed at a location in which the smart radio is to be used. For example, the wireless antennas 774 are omnidirectional, directional, or semidirectional depending on the intended coverage area. In embodiments, the wireless antennas 774 support a local cellular network. In embodiments, the local network is a private LTE network (e.g., based on 4G or 5G). In more specific embodiments, the network is a CBRS Band 48 local network. The frequency range for CBRS Band 48 extends from 3550 MHz to 3700 MHz and is executed using TDD as the duplex mode. The private LTE wireless communication device is configured to operate in the private network created, for example, to accommodate CBRS Band 48 in the frequency range for Band 48 (again, from 3550 MHz to 3700 MHz) and accommodates TDD. Thus, channels within the preferred range are used for different types of communications between the cloud and the local network.

### Geofencing

As described herein, smart radios are configured with location estimating capabilities and are used within a facility or worksite for which geofences are defined. A geofence refers to a virtual perimeter for a real-world geographic area, such as a portion of a facility or worksite. A smart radio includes location-aware devices that inform of the location of the smart radio at various times. Embodiments described herein relate to location-based features for smart radios or smart apparatuses. Location-based features described herein use location data for smart radios to provide improved functionality. In some embodiments, a location of a smart radio (e.g., a position estimate) is assumed to be representative of a location of a worker using or associated with the smart radio. As such, embodiments described herein apply location data for smart radios to perform various functions for workers of a facility or worksite.

Some example scenarios that require radio communication between workers are area-specific, or relevant to a given area of a facility. For example, when machines need repair, workers near the machine are notified and provided instructions to assist in the repair. Alternatively, if a hazard is present at the facility, workers near the hazard are notified.

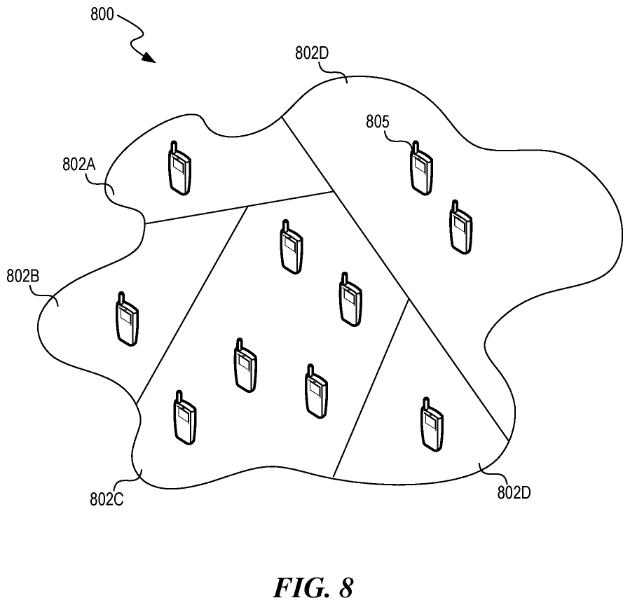

According to some embodiments, locations of smart radios are monitored such that at a point in time, each smart radio located in a specific geofenced area is identified. FIG. 8 illustrates an example of a worksite 800 that includes a plurality of geofenced areas 802, with smart radios 805 being located within the geofenced areas 802.

In some embodiments, an alert, notification, communication, and/or the like is transmitted to each smart radio 805 that is located within a geofenced area 802 (e.g., 802C) responsive to a selection or indication of the geofenced area 802. A smart radio 805, an administrator smart radio (e.g., a smart radio assigned to an administrator), or the cloud computing system is configured to enable user selection of one of the plurality of geofenced areas 802 (e.g., 802C). For example, a map display of the worksite 800 and the plurality of geofenced areas 802 is provided. With the user selection of a geofenced area 802 and a location for each smart radio 805, a set of smart radios 805 located within the geofenced area 802 is identified. An alert, notification, communication, and/or the like is then transmitted to the identified smart radios 805.

### ML System

FIG. 9 is a block diagram illustrating an example ML system 900, in accordance with one or more embodiments. The ML system 900 implements one or more components of the computer systems and apparatuses discussed herein. Although illustrated in a particular configuration, different embodiments of the ML system 900 include different and/or additional components and are connected in different ways. The ML system 900 is sometimes referred to as an ML module.

The ML system 900 includes a feature extraction module 908 implemented using components of an example computer system, as described herein. In some embodiments, the feature extraction module 908 extracts a feature vector 912 from input data 904. The feature vector 912 includes features 912a, 912b, . . . , 912n. The feature extraction module 908 reduces the redundancy in the input data 904, for example, repetitive data values, to transform the input data 904 into the reduced set of features 912, for example, features 912a, 912b, . . . , 912n. The feature vector 912 contains the relevant information from the input data 904, such that events or data value thresholds of interest are identified by the ML model 916 by using a reduced representation. In some example embodiments, the following dimensionality reduction techniques are used by the feature extraction module 908: independent component analysis, Isomap, principal component analysis (PCA), latent semantic analysis, partial least squares, kernel PCA, multifactor dimensionality reduction, nonlinear dimensionality reduction, multilinear PCA, multilinear subspace learning, semidefinite embedding, autoencoder, and deep feature synthesis.

In alternate embodiments, the ML model 916 performs deep learning (also known as deep structured learning or hierarchical learning) directly on the input data 904 to learn data representations, as opposed to using task-specific algorithms. In deep learning, no explicit feature extraction is performed; the features 912 are implicitly extracted by the ML system 900. For example, the ML model 916 uses a cascade of multiple layers of nonlinear processing units for implicit feature extraction and transformation. Each successive layer uses the output from the previous layer as input. The ML model 916 thus learns in supervised (e.g., classification) and/or unsupervised (e.g., pattern analysis) modes. The ML model 916 learns multiple levels of representations that correspond to different levels of abstraction, wherein the different levels form a hierarchy of concepts. The multiple levels of representation configure the ML model 916 to differentiate features of interest from background features.

In alternative example embodiments, the ML model 916, for example, in the form of a convolutional neural network (CNN), generates the output 924, without the need for feature extraction, directly from the input data 904. The output 924 is provided to the computer device 928. The computer device 928 is a server, computer, tablet, smartphone, smart speaker, etc., implemented using components of an example computer system, as described herein. In some embodiments, the steps performed by the ML system 900 are stored in memory on the computer device 928 for execution. In other embodiments, the output 924 is displayed on an apparatus or electronic displays of a cloud computing system.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 916 is a CNN that includes both convolutional layers and max pooling layers. For example, the architecture of the ML model 916 is “fully convolutional,” which means that variable sized sensor data vectors are fed into it. For convolutional layers, the ML model 916 specifies a kernel size, a stride of the convolution, and an amount of zero padding applied to the input of that layer. For the pooling layers, the ML model 916 specifies the kernel size and stride of the pooling.

In some embodiments, the ML system 900 trains the ML model 916, based on the training data 920, to correlate the feature vector 912 to expected outputs in the training data 920. As part of the training of the ML model 916, the ML system 900 forms a training set of features and training labels by identifying a positive training set of features that have been determined to have a desired property in question, and, in some embodiments, forms a negative training set of features that lack the property in question.

The ML system 900 applies ML techniques to train the ML model 916, such that when applied to the feature vector 912, output indications of whether the feature vector 912 has an associated desired property or properties, such as a probability that the feature vector 912 has a particular Boolean property, or an estimated value of a scalar property. In embodiments, the ML system 900 further applies dimensionality reduction (e.g., via linear discriminant analysis (LDA), PCA, or the like) to reduce the amount of data in the feature vector 912 to a smaller, more representative set of data.

In embodiments, the ML system 900 uses supervised ML to train the ML model 916, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 932 is formed of additional features, other than those in the training data 920, which have already been determined to have or to lack the property in question. The ML system 900 applies the trained ML model 916 to the features of the validation set 932 to quantify the accuracy of the ML model 916. Common metrics applied in accuracy measurement include Precision and Recall, where Precision refers to a number of results the ML model 916 correctly predicted out of the total it predicted, and Recall is a number of results the ML model 916 correctly predicted out of the total number of features that had the desired property in question. In some embodiments, the ML system 900 iteratively retrains the ML model 916 until the occurrence of a stopping condition, such as the accuracy measurement indication that the ML model 916 is sufficiently accurate, or a number of training rounds having taken place. In embodiments, the validation set 932 includes data corresponding to confirmed locations, dates, times, activities, or combinations thereof. This allows the detected values to be validated using the validation set 932. The validation set 932 is generated based on the analysis to be performed.

### Computing System

FIG. 10 is a block diagram illustrating an example computer system 1000, in accordance with one or more embodiments. At least some operations described herein are implemented on the computer system 1000. The computer system 1000 includes one or more central processing units (“processors”) 1002, main memory 1006, non-volatile memory 1010, network adapters 1012 (e.g., network interface), video displays 1018, input/output devices 1020, control devices 1022 (e.g., keyboard and pointing devices), drive units 1024 including a storage medium 1026, and a signal generation device 1030 that are communicatively connected to a bus 1016. The bus 1016 is illustrated as an abstraction that represents one or more physical buses and/or point-to-point connections that are connected by appropriate bridges, adapters, or controllers. In embodiments, the bus 1016 includes a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an IEEE standard 1394 bus (also referred to as “Firewire”).

In embodiments, the computer system 1000 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1000.

While the main memory 1006, non-volatile memory 1010, and storage medium 1026 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1028. The terms “machine-readable medium” and “storage medium” shall also be taken to include any medium that is capable of storing, encoding, or carrying a set of instructions for execution by the computer system 1000.

In general, the routines executed to implement the embodiments of the disclosure are implemented as part of an operating system or a specific application, component, program, object, module, or sequence of instructions (collectively referred to as “computer programs”). The computer programs typically include one or more instructions (e.g., instructions 1004, 1008, 1028) set at various times in various memory and storage devices in a computer device. When read and executed by the one or more processors 1002, the instruction(s) cause the computer system 1000 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1010, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 1012 enables the computer system 1000 to mediate data in a network 1014 with an entity that is external to the computer system 1000 through any communication protocol supported by the computer system 1000 and the external entity. In embodiments, the network adapter 1012 includes a network adapter card, a wireless network interface card, a router, an access point, a wireless router, a switch, a multilayer switch, a protocol converter, a gateway, a bridge, a bridge router, a hub, a digital media receiver, and/or a repeater.

In embodiments, the network adapter 1012 includes a firewall that governs and/or manages permission to access proxy data in a computer network and tracks varying levels of trust between different machines and/or applications. In embodiments, the firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall additionally manages and/or has access to an access control list that details permissions including the access and operation rights of an object by an individual, a machine, and/or an application, and the circumstances under which the permission rights stand.

In embodiments, the functions performed in the processes and methods are implemented in differing order. Furthermore, the outlined steps and operations are only provided as examples. For example, some of the steps and operations are optional, combined into fewer steps and operations, or expanded into additional steps and operations without detracting from the essence of the disclosed embodiments.

In embodiments, the techniques introduced here are implemented by programmable circuitry (e.g., one or more microprocessors), software and/or firmware, special-purpose hardwired (i.e., non-programmable) circuitry, or a combination of such forms. In embodiments, special-purpose circuitry is in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. It will be appreciated that the same thing can be said in more than one way. One will recognize that “memory” is one form of a “storage” and that the terms are on occasion used interchangeably.

Consequently, alternative language and synonyms are used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

1. A charging station system comprising:
a first mobile device in communication with a host server, wherein the first mobile device is configured to receive software update data from the host server, and wherein the software update data is configured to update mobile devices; and
a first charging station bank including:
one or more charging receptacles configured to receive corresponding mobile devices including the first mobile device, wherein the one or more charging receptacles are configured to charge and communicate with the corresponding mobile devices connected thereto;
a processor; and
a memory including the software update data obtained from the first mobile device, and instructions that when executed by the processor cause the first charging station bank to:
determine a software version of a second mobile device that is connected to the one or more charging receptacles; and
one of:
(i) provide the software update data to the second mobile device, wherein the second mobile device has an obsolete software version;
(ii) take no action with the second mobile device, wherein the second mobile device has a matching software version; or
(iii) replace the software update data with software update data from the second mobile device, wherein the second mobile device has a newer software version.

2. The system of claim 1, wherein the first charging station bank is further comprised of a network communication interface in communication with the host server.

3. The system of claim 2, wherein the first charging station bank is further configured to obtain the software data directly from the host server via the network communication interface.

4. The system of claim 3, wherein the first charging station bank is further configured to be part of a charging station network, wherein the first charging station bank is configured to communicate with other charging station banks that are part of the charging station network via the network communication interface.

5. The system of claim 4, wherein the memory of the first charging station bank is further configured to include instructions that when executed by the processor cause the first charging station bank to:
determine a version of stored software update data of a second charging station bank that is part of the charging station network; and one of:
(i) provide the software update data to the second charging station bank, wherein the second charging station bank has an obsolete software version;
(ii) take no action with the second charging station bank, wherein the second charging station bank has a matching software version; or
(iii) replace the software update data with software update data from the second charging station bank, wherein the second charging station bank has a newer software version.

6. The system of claim 5, wherein the second charging station bank includes elements corresponding to the first charging station bank, and wherein a memory of the second charging station bank is configured to include instructions that when executed by a processor of the second charging station bank cause the second charging station bank to:
determine a software version of a third mobile device that is connected to one or more charging receptacles of the second charging station bank; and one of:
(i) provide the software update data to the third mobile device, wherein the third mobile device has an obsolete software version;
(ii) take no action with the third mobile device, wherein the third mobile device has a matching software version; or
(iii) replace the software update data with software update data from the third mobile device, wherein the third mobile device has a newer software version.

7. The system of claim 1, wherein the one or more charging receptacles are further configured to communicate with the corresponding mobile devices connected thereto via near field communication (NFC).

8. The system of claim 1, wherein the first charging station bank is further configured to act as a wireless access point.

9. The system of claim 1, wherein the first charging station bank is further configured to operate as a known location for triangulation of a mesh network.

10. A charging station update system comprising:
a first mobile device in communication with a host server, wherein the first mobile device is configured to receive software update data from the host server, and wherein the software update data is configured to update mobile devices;
a first charging station bank including:
one or more charging receptacles configured to receive corresponding mobile devices including the first mobile device, wherein the one or more charging receptacles are configured to charge and communicate with the corresponding mobile devices connected thereto;
a first network communication interface;
a processor; and
a memory including the software update data obtained from the first mobile device; and
a second charging station bank including elements that correspond to the first charging station bank, the second charging station bank characterized by:
a second network communication interface in communication with the first charging station bank; and
a memory including the software update data obtained from the first charging station bank;
wherein the memory of the second charging station bank further includes instructions that when executed by a processor of the second charging station bank cause the second charging station bank to:
determine a software version of a second mobile device that is connected to one or more charging receptacles of the second charging station bank; and one of:
(i) provide the software update data to the second mobile device, wherein the second mobile device has an obsolete software version;
(ii) take no action with the second mobile device, wherein the second mobile device has a matching software version; or
(iii) replace the software update data with software update data from the second mobile device, wherein the second mobile device has a newer software version.

11. The system of claim 10, wherein the network communication interface of the first charging station bank is further in communication with the host server.

12. The system of claim 11, wherein the first charging station bank is further configured to obtain the software data directly from the host server via the network communication interface.

13. The system of claim 12, wherein the first charging station bank and the second charging station bank are further configured to be part of a charging station network, wherein the first charging station bank and the second charging station bank are configured to communicate with other charging station banks that are part of the charging station network via the first network communication interface and the second network communication interface.

14. The system of claim 13, wherein the memory of the first charging station bank is further configured to include instructions that when executed by the processor of the first charging station bank cause the first charging station bank to:
determine a version of stored software update data of an nth charging station bank in the charging station network; and one of:
(i) provide the software update data to the nth charging station bank, wherein the nth charging station bank has an obsolete software version;
(ii) take no action with the nth charging station bank, wherein the nth charging station bank has a matching software version; or
(iii) replace the software update data with software update data from the nth charging station bank, wherein the nth charging station bank has a newer software version.

15. The system of claim 13, wherein the memory of the second charging station bank is further configured to include instructions that when executed by the processor of the second charging station bank cause the second charging station bank to:
determine a version of stored software update data of an nth charging station bank in the charging station network; and one of:
(i) provide the software update data to the nth charging station bank, wherein the nth charging station bank has an obsolete software version;
(ii) take no action with the nth charging station bank, wherein the nth charging station bank has a matching software version; or
(iii) replace the software update data with software update data from the nth charging station bank, wherein the nth charging station bank has a newer software version.

16. The system of claim 10, wherein the one or more charging receptacles are further configured to communicate with the corresponding mobile devices connected thereto via near field communication (NFC).

17. The system of claim 10, wherein the first charging station bank is further configured to act as a wireless access point.

18. The system of claim 10, wherein the first charging station bank is further configured to operate as a known location for triangulation of a mesh network.

19. A method of updating mobile devices comprising:
establishing a communicative connection between a first mobile device and a host server, wherein the first mobile device is configured to receive software update data from the host server, and wherein the software update data is configured to update mobile devices;
transmitting the software update data from the first mobile device to a first charging station bank via one or more charging receptacles configured to charge connected corresponding mobile devices including the first mobile device, and wherein the one or more charging receptacles are configured to communicatively couple with the corresponding mobile devices connected thereto;
storing in a memory of the first charging station bank the software update data transmitted by the first mobile device; and
determining a software version of a second mobile device that is connected to the one or more charging receptacles; and
based on said determining, performing one of:
(i) provide the software update data to the second mobile device, wherein the second mobile device has an obsolete software version;
(ii) take no action with the second mobile device, wherein the second mobile device has a matching software version; or
(iii) replace the software update data with software update data from the second mobile device, wherein the second mobile device has a newer software version.

20. The method of claim 19, further comprising:
installing the software update data by the second mobile device, wherein the second mobile device has an obsolete software version.

21. The method of claim 19, wherein the first charging station bank is further configured to be part of a charging station network, wherein the first charging station bank is configured to communicate with other charging station banks that are part of the charging station network via a network communication interface.

22. The method of claim 21, wherein the memory of the first charging station bank is further configured to include instructions that when executed by a processor cause the first charging station bank to:
determine a software version of a second charging station bank that is part of the charging station network; and one of:
(i) provide the software update data to the second charging station bank, wherein the second charging station bank has an obsolete software version;
(ii) take no action with the second charging station bank, wherein the second charging station bank has a matching software version; or
(iii) replace the software update data with software update data from the second charging station bank, wherein the second charging station bank has a newer software version.

23. The method of claim 22, wherein the second charging station bank includes elements corresponding to the first charging station bank, and wherein a memory of the second charging station bank is configured to include instructions that when executed by a processor of the second charging station bank cause the second charging station bank to:
determine a software version of a third mobile device that is connected to one or more charging receptacles of the second charging station bank; and one of:
(i) provide the software update data to the third mobile device, wherein the third mobile device has an obsolete software version;
(ii) take no action with the third mobile device, wherein the third mobile device has a matching software version; or
(iii) replace the software update data with software update data from the third mobile device, wherein the third mobile device has a newer software version.

24. The method of claim 19, wherein the one or more charging receptacles are further configured to communicate with the corresponding mobile devices connected thereto via near field communication (NFC).

25. The method of claim 19, wherein the first charging station bank is further configured to act as a wireless access point.

26. The method of claim 19, wherein the first charging station bank is further configured to operate as a known location for triangulation of a mesh network.
